(19) United States
(12) Patent Application Publication
(10) Pub. No.: US 2026/0186756 A1
(43) Pub. Date: Jul. 2, 2026

(54) OFFLOAD SERVER, OFFLOAD CONTROL METHOD AND OFFLOAD PROGRAM

(71) Applicant: Nippon Telegraph and Telephone Corporation, Tokyo (JP)

(72) Inventor: Yoji YAMATO, Musashino-shi, Tokyo (JP)

(21) Appl. No.: 18/863,828

(22) PCT Filed: May 26, 2022
(86) PCT No.: PCT/JP2022/021602

§ 371 Date: Nov. 7, 2024

(51) Int. Cl. G06F 8/41; G06F 8/60

(52) U.S. Cl. CPC G06F 8/452; G06F 8/60

(57) ABSTRACT

An offload server (1) includes a parallel processing pattern creation unit (117) that excludes loop statements that cause compile errors from being offloaded, and creates a parallel processing pattern that specifies whether to perform parallel processing for loop statements that do not cause compile errors; a performance measuring unit (118) that compiles the application program of the parallel processing pattern, deploys it on an accelerator verification device, and executes processing of measuring performance when offloaded to the accelerator; and a deployment reconfiguration unit (180) that reconfigures deployment locations of a group of application programs requested to be deployed by a plurality of users requesting deployment of reconfiguration target applications according to a linear programming equation for reconfiguration for the deployed application programs.

### TECHNICAL FIELD

The present invention relates to an offload server, an offload control method, and an offload program for automatically offloading functional processing to an accelerator such as a GPU (Graphics Processing Unit) or FPGA (Field Programmable Gate Array), and deploying converted application programs (hereinafter referred to as applications) in an appropriate location.

### BACKGROUND ART

The use of heterogeneous computation resources other than CPU (Central Processing Unit) is increasing. For example, servers enhanced with GPUs (accelerators) have begun to perform image processing, and FPGAs (accelerators) have begun to accelerate signal processing. An FPGA is a programmable gate array whose configuration can be set by designers after manufacturing, and is a type of PLD (Programmable Logic Device). Amazon Web Services (AWS) (registered trademark) provides GPU instances and FPGA instances, and can also use these resources on demand. Microsoft (registered trademark) uses FPGAs to streamline searches.

A wide variety of applications are expected to be created using service collaboration technology, and by making use of even more advanced hardware, the performance of operating applications is expected to improve. However, in order to do so, programming and settings tailored to the operating hardware are required. For example, much technical knowledge is required, such as CUDA (Compute Unified Device Architecture) and OpenCL (Open Computing Language), and the hurdles are high. OpenCL is an open API (Application Programming Interface) that can handle all computation resources (not limited to CPUs and GPUs) in a unified manner without being tied to specific hardware.

In order to easily use GPUs and FPGAs in user applications, there are the following requirements. When deploying a general-purpose application for image processing or cryptographic processing to be operated to an environment, it is desirable for the platform to analyze the application logic and automatically offload the processing to the GPU or FPGA.

CUDA, a development environment for GPGPU (General Purpose GPU), which uses GPU computing power for purposes other than image processing, is being developed. CUDA is a development environment for a GPGPU. Additionally, OpenCL has emerged as a standard for handling heterogeneous hardware such as GPUs, FPGAs, and many-core CPUs in a unified manner.

CUDA and OpenCL perform programming by extending the C language. However, it is necessary to describe memory copying, release, and the like between a device such as a GPU and a CPU, which is difficult to describe. In reality, there are not many engineers who can master CUDA and OpenCL.

In order to easily implement a GPGPU, there is a technology that uses directives to specify parts that should be processed in parallel, such as loop statements, and has a compiler converting codes into device-specific codes according to the directives. Technical specifications include OpenACC (Open Accelerator), and compilers include PGI Compiler (registered trademark). For example, in an example using OpenACC, the user specifies that codes written in the C/C++/Fortran language should be processed in parallel using the OpenACC directive. The PGI compiler checks the parallelism of the codes, generates executable binaries for a GPU and a CPU, and converts the same into an executable module. IBM JDK (registered trademark) supports a function of offloading parallel processing specifications according to the lambda format of Java (registered trademark) to a GPU. By using these technologies, programmers do not need to be aware of data allocation to a GPU memory.

In this way, technologies such as OpenCL, CUDA, and OpenACC have made it possible to offload processing to GPUs and FPGAs.

However, even if offload processing itself can be performed, there are still many issues with proper offloading. For example, there are compilers such as the Intel Compiler (registered trademark) that have an automatic parallelization function. When performing automatic parallelization, parallel processing units such as for statements (repetition statements) in the program are extracted. However, when using GPUs to operate in parallel, performance often suffers due to the overhead of data exchange between the CPU and GPU memory. When speeding up using a GPU, it is necessary for skilled users to tune OpenCL or CUDA, or search for an appropriate parallel processing unit using a PGI compiler or the like. For this reason, it is difficult for unskilled users to improve the performance of applications using GPUs, and even when using automatic parallelization technology, trial and error tuning of whether to parallelize for statements is required, and thus, it takes a lot of time until the start of use.

Regarding deployment, there is research on optimizing the embedding position of a VN (Virtual Network) for a group of servers on a network in order to make optimal use of network resources (see NPL 1). In NPL 1, the optimal deployment of VNs is determined in consideration of communication traffic. However, the target is a virtual network with a single resource, and the purpose is to reduce the carrier's equipment cost and overall response time, and conditions such as the processing time of individual different applications and the cost and response time requirements of individual users are not taken into consideration.

NPL 2 is an example of an effort to automate the trial and error processing of extracting parallel processing areas. NPL 2 proposes environment-adaptive software for the purpose of automatically performing conversion, resource settings, and the like using codes that are written once to use GPUs, FPGAs, many-core CPUs, and the like that exist in the deployment environment, and run applications at high performance. Additionally, NPL 2 proposes a method for automatically offloading loop statements in application codes to a GPU as an element of environment-adaptive software, and evaluates the performance improvement.

NPL 3 proposes a method for automatically offloading loop statements in application codes to an FPGA as an element of environment-adaptive software, and evaluates the performance improvement.

NPL 4 evaluates a method of optimizing the amount of resources (such as the number of virtual machine cores) used to execute an application after automatic conversion for GPUs or the like as an element of environment-adaptive software.

### CITATION LIST

### Non Patent Literature

[NPL 1] Kota Kawashima, Tatsuya Otoshi, Yuichi Oshita, Masayuki Murata, “Virtual network embedding method with scalability based on distributed model predictive control,” IEICE technical report, vol. 115, pp. 19-24, 2015.
[NPL 2] Y. Yamato, “Study of parallel processing area extraction and data transfer number reduction for automatic GPU offloading of IoT applications,” Journal of Intelligent Information Systems, Springer, DOI: 10.1007/s10844-019-00575-8, August 2019. (Electronic Publishing) Vol. 54, No. 3, pp. 567-584, May 2020. (Print Publishing) [NPL 3]Y. Yamato, “Automatic Offloading Method of Loop Statements of Software to FPGA,” International Journal of Parallel, Emergent and Distributed Systems, Taylor & Francis, DOI: 10.1080/17445760.2021.1916020, April 2021.
[NPL 4]Y. Yamato, “Arranging resource amount after automatic GPU offloading,” The Ninth International Symposium on Computing and Networking (CANDAR 2021), November 2021.

### SUMMARY OF INVENTION

### Technical Problem

NPLs 1 to 4 mainly evaluate the reduction in processing time during automatic offloading.

When offloading processing to a heterogeneous device such as a GPU or FPGA, there is a problem in that there is no proposal for making the converted application operate while satisfying user requirements (cost and response time).

The present invention has been made in view of these points, and an object of the present invention is to optimally deploy applications to meet user's requirements such as cost or response time when the applications are automatically converted so that the applications can be deployed on offload devices such as GPUs and FPGAs. Another object of the present invention is to improve the satisfaction level of a plurality of users who request the deployment of reconfiguration target applications by reconfiguring the deployment after the start of operation.

### Solution to Problem

In order to solve the above-mentioned problems, there is provided an offload server that offloads specific processing of an application program to an accelerator, the offload server including: an application code analysis unit that analyzes a source code of the application program; a data transfer specifying unit that analyzes reference relationships of variables used in loop statements of the application program, and, for data that can be transferred outside the loop, specifies data transfer using explicit specification lines that explicitly specify data transfer outside the loop; a parallel processing specifying unit that identifies loop statements in the application program, and specifies and compiles each of the identified loop statements by specifying a parallel processing specifying statement in the accelerator; a parallel processing pattern creation unit that excludes loop statements that cause compile errors from being offloaded, and creates a parallel processing pattern that specifies whether to perform parallel processing for loop statements that do not cause compile errors; a performance measuring unit that compiles the application program of the parallel processing pattern, deploys it on an accelerator verification device, and executes processing of measuring performance when offloaded to the accelerator; and a deployment reconfiguration unit that reconfigures deployment locations of a group of application programs requested to be deployed by a plurality of users requesting deployment of reconfiguration target applications according to a linear programming equation for reconfiguration for the deployed application programs.

### Advantageous Effects of Invention

According to the present invention, it is possible to optimally deploy applications so as to meet the user's requirements such as cost or response time when the applications are automatically converted so that the applications can be deployed on offload devices such as GPUs and FPGAs. Furthermore, it is possible to improve the satisfaction level of a plurality of users who request the deployment of reconfiguration target applications by reconfiguring the deployment after the start of operation.

### BRIEF DESCRIPTION OF DRAWINGS

FIG. 1 is a functional block diagram showing a configuration example of an offload server according to a first embodiment of the present invention.

FIG. 2 is a diagram showing automatic offload processing using the offload server according to the first embodiment.

FIG. 3 is a diagram showing a search image of a control unit (automatic offload function unit) by Simple GA of the offload server according to the first embodiment.

FIG. 4 is a diagram showing an example of a normal CPU program as a comparative example.

FIG. 5 is a diagram showing an example of a loop statement when data is transferred from the CPU to the GPU using the simple CPU program of the comparative example.

FIG. 6 is a diagram showing an example of a loop statement when data is transferred from the CPU to the GPU when nest batching is performed in the offload server according to the first embodiment.

FIG. 7 is a diagram showing an example of a loop statement when data is transferred from the CPU to the GPU when transfer batching is performed in the offload server according to the first embodiment.

FIG. 8 is a diagram showing an example of a loop statement when data is transferred from the CPU to the GPU when transfer batching is performed and a temporary area is used in the offload server according to the first embodiment.

FIG. 9A is a flowchart showing an overview of the operation of implementation of the offload server according to the first embodiment.

FIG. 9B is a flowchart showing an overview of the operation of implementation of the offload server according to the first embodiment.

FIG. 10 is a flowchart showing setting of a resource ratio and the amount of resources added after a GPU offload attempt is performed in the offload server according to the first embodiment, and deployment of a new application.

FIG. 11 is a diagram showing an example of the topology of the computation nodes of the offload server according to the first embodiment.

FIG. 12 is a graph showing changes in the number of applications deployed in the average response time of the offload server according to the first embodiment.

FIG. 13 is a flowchart of reconfiguration for overall optimal deployment of the offload server according to the first embodiment, taking the deployment status of other users into consideration.

FIG. 14 is a graph showing changes in the number of applications actually configured in the offload server according to the first embodiment.

FIG. 15 is a graph showing changes in Rₖ^{after}/Rₖ^{before}+Pₖ^{after}/Pₖ^{before} of an application actually reconfigured in the offload server according to the first embodiment.

FIG. 16 is a functional block diagram showing a configuration example of an offload server according to a second embodiment of the present invention.

FIG. 17 is a flowchart showing an overview of the operation of implementation of the offload server according to the second embodiment.

FIG. 18 is a flowchart showing performance measurement processing of a performance measuring unit of the offload server according to the second embodiment.

FIG. 19 is a diagram showing a search image of a PLD processing pattern creation unit of the offload server according to the second embodiment.

FIG. 20 is a diagram showing the flow from the C code to the search for the OpenCL final solution in the offload server according to the second embodiment.

FIG. 21 is a hardware configuration diagram showing an example of a computer that implements the functions of an offload server according to each embodiment of the present invention.

### DESCRIPTION OF EMBODIMENTS

An offload server according to an embodiment of the present invention (hereinafter referred to as “the present embodiment”) will be described below with reference to the drawings.

### (Basic Idea of Automatic Offloading of Present Invention)

In order to embody the concept of environment-adaptive software, the present inventor has proposed methods for automatically offloading program loop statements to GPUs, automatically offloading FPGAs, and optimizing execution resources for conversion applications (see NPLs 2, 3, and 4). The basic idea of the present invention will be described based on consideration of the elemental technologies of these NPLs 2, 3, and 4.

### <Optimizing Resource Ratio Between CPU and Offload Device>

First, optimization of the resource ratio between the CPU and the offload device after converting the program to be offloaded to the device will be described.

Using the method described in NPL 2, it is possible to automatically offload a normal program to an offload device such as a GPU or FPGA.

Currently, multi-core CPUs and many-core CPUs are virtualized using virtual machines and containers, making it possible to flexibly allocate an arbitrary percentage of the total cores. GPUs have also been virtualized in the same way as CPUs in recent years, making it possible to allocate an arbitrary percentage of the GPU's total cores. Regarding FPGAs, resource usage is often expressed by the number of configured look up tables and flip flops, and unused gates can be used for other purposes.

In this way, it is possible to operate the CPU, GPU, and FPGA using only a portion of the total resources, and optimizing the resources of the CPU and offload devices according to the purpose is important for improving cost performance.

Furthermore, it is possible to convert an application into codes for CPU and GPU processing using the method described in NPL 2 and the like. However, even if the code itself is appropriate, performance will not be achieved if the amounts of CPU and GPU resources are not properly balanced. For example, when performing certain processing, if the CPU processing time is 1000 seconds and the GPU processing time is 1 second, even if the GPU speeds up the processing that can be offloaded to some extent, the CPU will become the overall bottleneck.

Furthermore, in NPL 5, “K. Shirahata, H. Sato and S. Matsuoka, “Hybrid Map Task Scheduling for GPU-Based Heterogeneous Clusters,” IEEE Second International Conference on Cloud Computing Technology and Science (CloudCom), pp. 733-740, December 2010”, when tasks are processed using the MapReduce (registered trademark) framework using the CPU and GPU, by distributing Map tasks so that the execution times of the CPU and GPU are the same, the overall performance is improved.

The inventor came up with the idea of determining the resource ratio between the CPU and the offload device as follows. In order to prevent the processing on a certain device from becoming a bottleneck, the resource ratio between the CPU and the offload device (hereinafter referred to as “resource ratio”) is determined so that the processing times of the CPU and the offload device are on the same order based on the processing time of the test case, referring to the NPLs mentioned above.

In addition, the present inventor adopts a method of gradually increasing speed based on performance measurement results in a verification environment during automatic offloading, as in the method of NPL 2. This is because performance varies greatly depending on not only the code structure but also the actual processing content, such as the specifications of the actual processing hardware, data size, and loop count. In addition, this is because performance is difficult to predict statically and requires dynamic measurement. Therefore, since performance measurement results in the verification environment are already available at the time of code conversion, the resource ratios are determined using those results.

When measuring performance, a test case is specified and the measurement is performed. For example, if the processing time for a test case in the verification environment is 10 seconds for CPU processing and 5 seconds for GPU processing, it is considered that the resources on the CPU side are doubled and the processing time is about the same. Therefore, the resource ratio is 2:1. In addition, if a user wishes to speed up particular processing by offloading, the user's requirement is reflected by preparing a test case that includes that processing and speeding up the test case using the method described in NPL 2.

### <Determination and Automatic Verification of CPU and Offload Device Resource Amounts>

Next, the determination and automatic verification of the amounts of the CPU and offload device resources (hereinafter referred to as “resource amount”) will be explained.

When the resource ratio is determined by <Optimization of resource ratio between CPU and offload device>, applications are deployed in a commercial environment.

In deployment in a commercial environment, the resource amount is determined while keeping (maintaining) the resource ratio as much as possible to meet the cost requirements specified by the user. For example, it is assumed that 1 VM costs 1,000 yen/month for a CPU and 4,000 yen/month for a GPU, and a resource ratio of 2:1 is appropriate. It is assumed that the user's budget is within 10,000 yen per month. In this case, even if the resource ratio is 2:1, it will still be within the user's budget of 10,000 yen per month, so the resource amount that maintains the appropriate resource ratio of 2:1 (that is, the CPU is “2” and the GPU is “1”) will be secured and applications will be deployed in a commercial environment. Furthermore, if the user's budget is less than 5,000 yen per month, an appropriate resource ratio of 2:1 cannot be maintained. In this case, applications are deployed while securing “1” for the CPU and “1” for the GPU as the resource amount.

After resources are secured and programs are deployed in a commercial environment, automatic verification is performed to ensure that it works before users use it. In automatic verification, performance verification test cases and regression test cases are executed. In the performance verification test case, a hypothetical test case specified by the user is executed using an automatic test execution tool such as Jenkins (registered trademark), and processing time, throughput, and the like are measured. A regression test case acquires information about software such as middleware and an OS installed on the system, and executes regression tests corresponding to them using Jenkins or the like. Studies on how to perform these automatic verifications by preparing a small number of test cases have been done in NPL 6 (Y. Yamato, “Automatic verification technology of software patches for user virtual environments on IaaS cloud,” Journal of Cloud Computing, Springer, 2015, 4:4, DOI: 10.1186/s13677-015-0028-6, February 2015) and the like, and the technique of this NPL 6 is used.

In the performance verification test case, it is checked whether the calculation results are incorrect even when offloaded. In the performance verification test case, the difference in calculation results compared to when offloading is not performed is also checked. For example, the PGI compiler that processes the GPU is an API (Application Programming Interface) called PGI_compare (registered trademark) and acc_compare (registered trademark) of the function PCAST (registered trademark) and can check the difference in calculation results when using and not using the GPU.

Note that even if parallel processing is correctly offloaded, the calculation results may not match completely due to differences in rounding errors between GPUs and CPUs. Therefore, for example, a check based on the IEEE 754 specifications is performed, and an acceptable difference is presented to the user, and the user is asked to confirm the presented difference.

As a result of automatic verification, information on the processing time of the performance verification test case, its throughput, and calculation result difference, and regression test execution results are presented to the user. The user is also presented with the secured resources (number of VMs, specifications, and the like) and their price, and the user refers to this information to decide whether to start operation.

### <Resources, Resource Ratio, Test Case Processing Time>

Resources, resource ratios, and test case processing time in the present embodiment will be described.

### About Resources

CPUs, GPUs, FPGAs, and the like are increasingly being provided as instances of virtual resources.

Examples of resources include the number of cores, clocks, and a memory amount of the CPU, disk size, the number of cores, clocks, and a memory amount of the GPU, and FPGA gate size (LE (registered trademark) for Intel (registered trademark) and LC (registered trademark) for Xilinx (registered trademark) is the unit). Cloud providers package these resources and provide them in the form of small-sized virtual machines or GPU instances. When virtualizing, the number of instances used can be said to be the amount of resources used.

### About Resource Ratio

The ratio of the numbers of instances of CPUs, GPUs, and FPGAs is the resource ratio. If the numbers of instances are 1, 2, and 3, the resource ratio is 1:2:3.

### About Test Case Processing Time

The present embodiment searches for and discovers offload patterns that speed up test cases specified by the user. In the case of a DB (database), the test case is the number of transactions processed like TPC-C (registered trademark). In the case of FFT, the test case is the execution of Fourier transform processing on sample data. The processing time is the execution time when the sample processing is executed. For example, the execution times when executed on the CPU and when executed on an offload device are acquired in a form that the processing time for processing A was 10 seconds before offloading, but it was 2 seconds after offloading.

### <Discovery of Loop Statement>

At present, it is difficult for the compiler to find the fitness of this loop statement for GPU parallel processing. It is difficult to predict how much performance and power consumption will result from offloading to the GPU unless it is actually measured. Therefore, trial-and-error measurements are being performed by manually instructing to offload this loop statement to the GPU.

The present invention automatically discovers appropriate loop statements to be offloaded to the GPU using a genetic algorithm (GA), which is an evolutionary calculation method. That is, for a group of parallelizable loop statements, a value of 1 is set for GPU execution and a value of 0 is set for CPU execution to geneticize values, and then repeated measurements are performed in a verification environment to search for an appropriate pattern.

### First Embodiment

Next, an offload server 1 and the like in a mode for carrying out the present invention (hereinafter referred to as “the present embodiment”) will be described.

### [GPU Automatic Offload of Loop Statements]

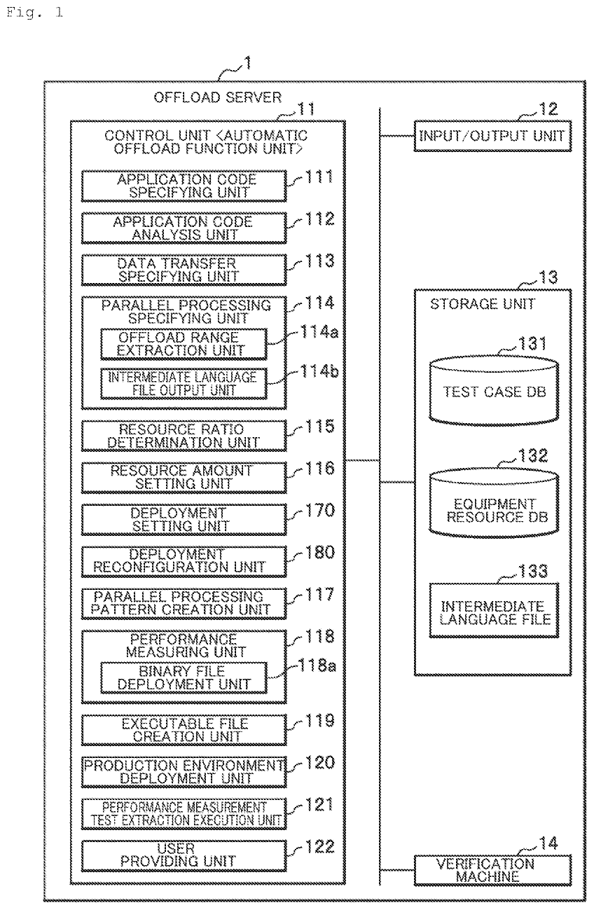

FIG. 1 is a functional block diagram showing a configuration example of the offload server 1 according to the first embodiment of the present invention.

The offload server 1 is a device that automatically offloads specific processing of an application to an accelerator.

As shown in FIG. 1, the offload server 1 includes a control unit 11, an input/output unit 12, a storage unit 13, and a verification machine 14 (accelerator verification device).

The input/output unit 12 includes a communication interface for transmitting and receiving information with each device, and an input/output interface for transmitting and receiving information between input devices such as touch panels and keyboards and output devices such as monitors.

The storage unit 13 is composed of a hard disk, flash memory, RAM (Random Access Memory), and the like, and temporarily stores programs (offload programs) for executing each function of the control unit 11 and an intermediate language file (intermediate file 133) necessary for the processing of the control unit 11.

The storage unit 13 includes a test case DB (test case database) 131, an equipment resource DB 132, and an intermediate language file (Intermediate file) 133.

The test case DB 131 stores data of test items corresponding to the software to be verified. For example, in the case of a database system such as MySQL, the test item data is data of a transaction test such as TPC-C.

The equipment resource DB 132 holds information prepared in advance such as resources such as servers and prices held by the business operator, and information on how much these are used. For example, the information indicates that there are ten servers that can accommodate three GPU instances, one GPU instance costs 5,000 yen per month, and two servers A and B among the ten servers are fully used, and only one instance is used in one server C. This information is used to determine the amount of resources to be secured when the user specifies operating conditions (conditions such as cost and performance). User operating conditions include cost conditions (for example, budget within 10,000 yen per month) specified by the user when requesting offloading, and performance conditions (for example, transaction throughput of TPC-C or the like and sample Fourier transform processing time per thread (for example, within certain seconds or the like)).

The intermediate language file 133 temporarily stores information necessary for processing by the control unit 11 in the form of a programming language interposed between a high-level language and a machine language.

The verification machine 14 is equipped with a CPU, GPU, and FPGA as a verification environment for environment-adaptive software.

The control unit 11 is an automatic offloading function unit that controls the entire offload server 1. The control unit 11 is realized, for example, by a CPU (Central Processing Unit) (not shown) expanding an application program (offload program) stored in the storage unit 13 into a RAM and executing it.

The control unit 11 includes an application code specifying unit (specify application code) 111, an application code analysis unit (analyze application code) 112, a data transfer specifying unit 113, a parallel processing specifying unit 114, a resource ratio determination unit 115, a resource amount setting unit 116, a deployment setting unit 170, a deployment reconfiguration unit 180, a parallel processing pattern creation unit 117, a performance measuring unit 118, an executable file creation unit 119, a production environment deployment unit (deploy final binary files to production environment) 120, a performance measurement test extraction execution unit (extract performance test cases and run automatically) 121, and a user providing unit (provide price and performance to a user to judge) 122.

### <Application Code Specifying Unit 111>

The application code specifying unit 111 specifies an input application code. Specifically, the application code specifying unit 111 passes the application code written in the received file to the application code analysis unit 112.

### <Application Code Analysis Unit 112>

The application code analysis unit 112 analyzes the source code of the processing function and understands structures such as loop statements and FFT library calls.

### <Data Transfer Specifying Unit 113>

The data transfer specifying unit 113 analyzes the reference relationships of variables used in loop statements of the application program. For data that may be transferred outside the loop, the data transfer specifying unit 113 specifies data transfer using explicit specification lines that explicitly specify data transfer outside the loop (#pragma acc kernels, #pragma acc data copyin(a,b), #pragma acc data copyout(a,b), #prama acc parallel loop, #prama acc parallel loop vector, and the like described later).

### <Parallel Processing Specifying Unit 114>

The parallel processing specifying unit 114 identifies loop statements (repetition statements) of the application program, and specifies and compiles each loop statement by specifying a parallel processing specifying statement in the accelerator. The parallel processing specifying unit 114 includes an offload range extraction unit (extract offloadable area) 114a and an intermediate language file output unit (output intermediate file) 114b.

The offload range extraction unit 114a identifies processing that can be offloaded to GPU/FPGA, such as loop statements and FFT, and extracts an intermediate language corresponding to the offload processing.

The intermediate language file output unit 114b outputs the extracted intermediate language file 133. The intermediate language extraction is not terminated at once, and repeated for attempting and optimizing execution for appropriate offload area search.

### <Resource Ratio Determination Unit 115>

The resource ratio determination unit 115 determines the processing times of the CPU and offload device (test case CPU processing time and offload device processing time) as a resource ratio based on the performance measurement results (described later). Specifically, the resource ratio determination unit 115 determines the resource ratio so that the processing times of the CPU and the offload device are on the same order. Furthermore, when the difference between the processing times of the CPU and the offload device is equal to or greater than a predetermined threshold, the resource ratio determination unit 115 sets the resource ratio to a predetermined upper limit.

### <Resource Amount Setting Unit 116>

Based on the determined resource ratio, the resource amount setting unit 116 sets the resource amounts of the CPU and offload device so as to satisfy a predetermined cost condition (described later). Specifically, the resource amount setting unit 116 maintains the determined resource ratio and sets the maximum resource amounts that satisfy the predetermined cost condition. Further, if the predetermined cost condition is not satisfied with the setting of the minimum resource amount while maintaining the determined resource ratio, the resource amount setting unit 116 changes the resource ratio and sets the resource amounts of the CPU and the offload device to a smaller value (for example, minimum) that satisfy the cost condition.

### <Deployment Setting Unit 170>

The deployment setting unit 170 calculates and sets the deployment location of the application based on a linear programming equation using the cost of devices and links, the upper limit of computation resources, and the upper limit of bandwidth as constraint conditions, and the cost or response time of computation resources as an objective function when deploying the converted application on a cloud server, a carrier edge server, or a user edge server on the network, depending on the cost or response time conditions specified by the user. Specifically, the deployment setting unit 170 uses a linear programming method to calculate and set the deployment location of the new application (APL deployment location) based on the server, link specification information, and existing application deployment information in the equipment resource DB 132. In the linear programming method, for example, objective functions and constraint conditions of linear programming equations shown in Equations (1), (5), (3), and (4) below are used. The linear programming equations shown in Equations (1), (5), (3), and (4) below are stored in the equipment resource DB 132, and the deployment setting unit 170 reads them from the equipment resource DB 132 and the equations are expanded on the memory processed by the deployment setting unit 170.

### <Deployment Reconfiguration Unit 180>

The deployment reconfiguration unit 180 uses linear programming equations (see Equations (7), (1), (5), (3), and (4) to be described later) for reconfiguration of the deployed application programs set by the deployment setting unit 170 to reconfigure the deployment locations of a group of application programs requested by a plurality of users requesting deployment of the reconfiguration target applications.

The deployment reconfiguration unit 180 uses the sum of the application program groups shown in Equation (7) below as an objective function (see objective functions for user satisfaction level evaluation), calculates the deployment in which the objective function is minimized, and redeploys the application program groups in batches at the position determined by the calculation.

### <Parallel Processing Pattern Creation Unit 117>

The parallel processing pattern creation unit 117 excludes loop statements (repetition statements) that cause compile errors from being offloaded, and creates a parallel processing pattern that specifies whether to perform parallel processing for repetition statements that do not cause compile errors.

### <Performance Measuring Unit 118>

The performance measuring unit 118 compiles the application program of the parallel processing pattern, deploys it on the verification machine 14, and executes processing of measuring performance when offloaded to the accelerator.

The performance measuring unit 118 includes a binary file deployment unit (deploy binary files) 118a. The binary file deployment unit 118a deploys an executable file derived from the intermediate language to the verification machine 14 equipped with a GPU or FPGA.

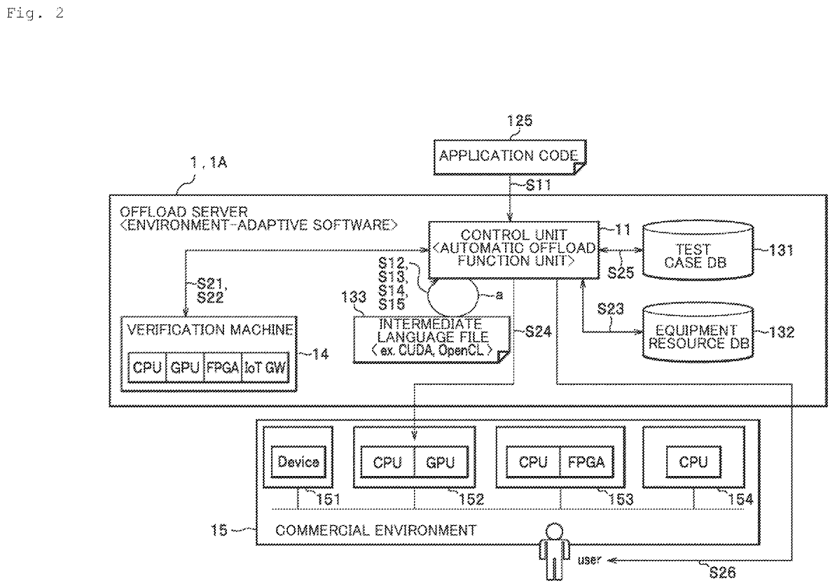

The performance measuring unit 118 executes the deployed binary file, measures the performance when offloaded, and returns the performance measurement result to the offload range extraction unit 114a. In this case, the offload range extraction unit 114a extracts another parallel processing pattern, and the intermediate language file output unit 114b attempts performance measurement based on the extracted intermediate language (see symbol a in FIG. 2 below).

### <Executable File Creation Unit 119>

The executable file creation unit 119 selects a plurality of parallel processing patterns with high processing performance from a plurality of parallel processing patterns based on the performance measurement results repeated a predetermined number of times, and creates a plurality of parallel processing patterns by performing crossover and mutation processing on the parallel processing patterns with high processing performance. Then, the executable file creation unit 119 performs new performance measurements, and after a specified number of performance measurements, selects the parallel processing pattern with the highest processing performance from the plurality of parallel processing patterns based on the performance measurement results, and compiles the parallel processing pattern with the highest processing performance to create an executable file.

### <Production Environment Deployment Unit 120>

The production environment deployment unit 120 deploys the created executable file in a production environment for users (“deployment of final binary file in production environment”). The production environment deployment unit 120 determines the pattern specifying a final offload area and deploys it to the production environment for users.

### <Performance Measurement Test Extraction Execution Unit 121>

After deploying the executable file, the performance measurement test extraction execution unit 121 extracts performance test items from the test case DB 131 and executes a performance test (“deployment of final binary file in production environment”).

After deploying the executable file, the performance measurement test extraction execution unit 121 extracts performance test items from the test case DB 131 and automatically executes the extracted performance tests in order to show the performance to the user.

### <User Providing Unit 122>

The user providing unit 122 presents information such as price and performance to the user based on the performance test results (“providing information such as price and performance to users”). The test case DB131 stores performance test items. The user providing unit 122 presents data such as price and performance to the user along with the performance test results based on the performance test results corresponding to the test items stored in the test case DB 131. The user determines the start of charging use of the service on the basis of the presented information such as the price and the performance. Here, the technology of NPL 7 (Y. Yamato, M. Muroi, K. Tanaka and M. Uchimura, “Development of Template Management Technology for Easy Deployment of Virtual Resources on OpenStack,” Journal of Cloud Computing, Springer, 2014, 3:7, DOI: 10.1206/s13677-014-0007-3, 12 pages, June 2014) may be used for bulk deployment to the production environment, and the technology of NPL 6 may be used for automatic performance tests.

### [Application of Genetic Algorithm]

The offload server 1 can use GA (Genetic Algorithms) for offload optimization. The configuration of the offload server 1 when using GA is as follows.

That is, the parallel processing specifying unit 114 uses the number of loop statements (repetition statements) that do not cause a compile error as a gene length based on a genetic algorithm. The parallel processing pattern creation unit 117 maps accelerator processing availability to a gene pattern by setting either 1 or 0 if accelerator processing is to be performed and the other 0 or 1 if not.

The parallel processing pattern creation unit 117 prepares gene patterns for a specified number of genes in which each gene value is randomly created as 1 or 0. The performance measuring unit 118 compiles an application code specifying a parallel processing specifying statement in the accelerator according to each gene, and deploys it in the verification machine 14. The performance measuring unit 118 executes the performance measurement processing in the verification machine 14.

Here, if a gene with the same parallel processing pattern as before occurs in an intermediate generation, the performance measuring unit 118 does not perform compiling of the application code corresponding to the parallel processing pattern and performance measurement and uses the same value as the performance measurement value.

In addition, the performance measuring unit 118 treats application codes in which a compile error occurs and performance measurement does not end within a predetermined time as timeouts, and sets the performance measurement value to a predetermined time (long time).

The executable file creation unit 119 measures the performance of all genes, and evaluates the genes such that the shorter the processing time, the higher the fitness. The executable file creation unit 119 selects genes whose fitness is higher than a predetermined value (for example, the top n of the total number, or the top m of the total number, where n and m are natural numbers) from all the genes as genes with high performance, performs crossover and mutation processing on the selected genes to create the next generation genes. The executable file creation unit 119 selects the parallel processing pattern with the highest performance as a solution after the processing of the specified number of generations is terminated.

The automatic offload operation of the offload server 1 configured as described above will be described below.

### [Automatic Offload Operation]

FIG. 2 is a diagram showing automatic offload processing using the offload server 1.

As shown in FIG. 2, the offload server 1 is applied to elemental technology of environment-adaptive software. The offload server 1 includes the control unit (automatic offload function unit) 11, the test case DB 131, the equipment resource DB 132, the intermediate language file 133, and the verification machine 14.

The offload server 1 acquires an application code 125 used by the user.

The user is, for example, a person who has signed a contract to use various devices (device 151, device 152 with CPU-GPU, device 153 with CPU-FPGA, and device 154 with CPU).

The offload server 1 automatically offloads functional processing to the accelerator of the device 152 with CPU-GPU and the device 153 with CPU-FPGA.

Hereinafter, an operation of each unit will be described with reference to the step number of FIG. 2.

### <Step S11: Specify Application Code>

In step S11, the application code specifying unit 111 (see FIG. 1) passes the application code written in the received file to the application code analysis unit 112.

### <Step S12: Analyze Application Code>

In step S12, the application code analysis unit 112 (see FIG. 1) analyzes the source code of the processing function and understands the structure of loop statements, FFT library calls, and the like

### <Step S13: Extract Offloadable Area>

In step S13, the parallel processing specifying unit 114 (see FIG. 1) identifies loop statements (repetition statements) of the application, specifies and compiles each repetition statement by specifying parallel processing specifying statements in the accelerator. Specifically, the offload range extraction unit 114a (see FIG. 1) specifies processing that can be offloaded to GPU/FPGA, such as loop statements and FFTs, and extracts an intermediate language corresponding to the offload processing.

### <Step S14: Output Intermediate File>

In step S14, the intermediate language file output unit 114b (see FIG. 1) outputs the intermediate language file 133. The intermediate language extraction is not terminated at once, and repeated for attempting and optimizing execution for appropriate offload area search.

### <Step S15: Compile Error>

In step S15, the parallel processing pattern creation unit 117 (see FIG. 1) excludes loop statements that cause compile errors from being offloaded, and creates a parallel processing pattern that specifies whether to perform parallel processing for repetition statements that do not cause compile errors.

### <Step S21: Deploy Binary Files>

In step S21, the binary file deployment unit 118a (see FIG. 1) deploys an executable file derived from the intermediate language to the verification machine 14 equipped with a GPU/FPGA.

### <Step S22: Measure Performances>

In a step S22, the performance measuring unit 118 (see FIG. 1) executes the deployed file, and measures the performance when offloaded.

In order to make the area to be offloaded more appropriate, this performance measurement result is returned to the offload range extraction unit 114a, and the offload range extraction unit 114a extracts another pattern. Then, the intermediate language file output unit 114b attempts performance measurement based on the extracted intermediate language (see symbol a in FIG. 2).

As indicated by symbol a in FIG. 2, the control unit 11 repeatedly executes steps S12 to S22. The automatic offload function of the control unit 11 is summarized below. That is, the parallel processing specifying unit 114 identifies loop statements (repetition statements) in the application program, specifies parallel processing specifying statements in the GPU for each repetition statement, and compiles the parallel processing specifying statement. Then, the parallel processing pattern creation unit 117 excludes loop statements (repetition statements) that cause compile errors from being offloaded, and creates a parallel processing pattern that specifies whether to perform parallel processing for repetition statements that do not cause compile errors. Then, the binary file deployment unit 118a compiles the application program of the corresponding parallel processing pattern and deploys it on the verification machine 14, and the performance measuring unit 118 executes the performance measurement processing on the verification machine 14. The executable file creation unit 119 selects the pattern of the highest processing performance from the plurality of parallel processing patterns on the basis of the performance measurement result repeated a predetermined number of times, and creates the executable file by compiling the selected pattern.

### <Step S23: Resource Amount Setting Based on User Operating Conditions>

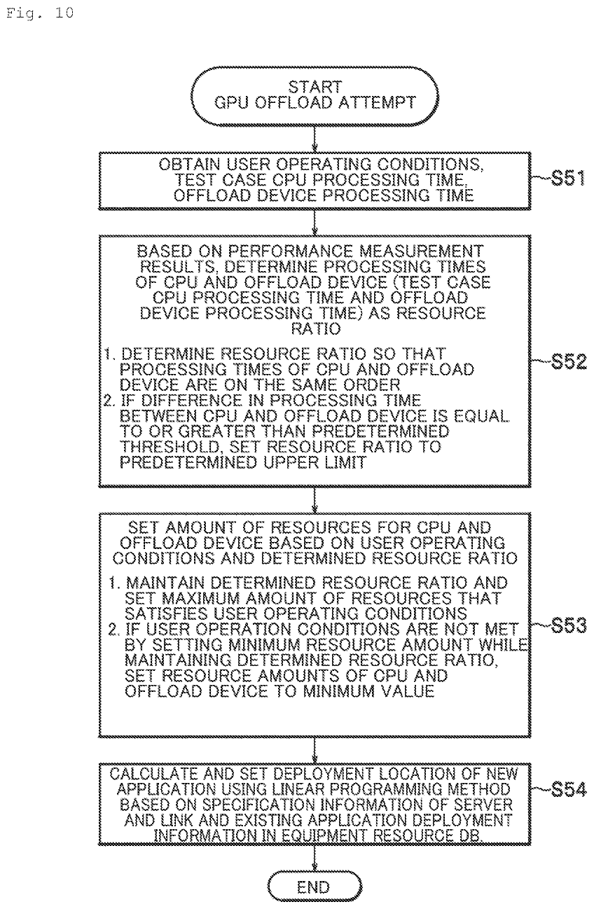

In step S23, the control unit 11 performs resource amount setting based on user operating conditions. That is, the resource ratio determination unit 115 of the control unit 11 determines the resource ratio between the CPU and the offload device. Then, based on the determined resource ratio, the resource amount setting unit 116 refers to the information in the equipment resource DB 132 and sets the resource amounts of the CPU and the offload device so as to satisfy the user operation conditions (see FIG. 10 described later).

### <Step S24: Deploy Final Binary Files to Production Environment>

In step S24, the production environment deployment unit 120 determines the pattern specifying a final offload area and deploys it to a production environment for users.

### <Step S25: Extract Performance Test Cases and Run Automatically>

In step S25, after deploying the executable file, the performance measurement test extraction execution unit 121 extracts performance test items from the test case DB 131 and automatically executes the extracted performance tests in order to show the performance to the user.

### <Step S26: Provide Price and Performance to a User to Judge>

In step S26, the user providing unit 122 presents information such as price and performance based on the performance test result to the user. The user determines the start of charging use of the service on the basis of the presented information such as the price and the performance.

Steps S11 to S26 are performed, for example, in the background of the user's use of the service, and are assumed to be performed, for example, during the first day of temporary use.

As mentioned above, when applied to the elemental technology of environment-adaptive software, the control unit (automatic offload function unit) 11 of the offload server 1 extracts an area to be offloaded from the source code of the application program used by the user in order to offload functional processing and outputs an intermediate language (steps S11 to S15). The control unit 11 deploys and executes the executable file derived from the intermediate language on the verification machine 14, and verifies the offload effect (steps S21 to S22). After repeating the verification and determining an appropriate offload area, the control unit 11 deploys the executable file to the production environment actually provided to the user and provides it as a service (steps S23 to S26).

### [GPU Automatic Offload Using GA]

GPU automatic offloading is processing for repeating steps S12 to S22 in FIG. 2 for the GPU and finally obtaining offload codes to be deployed in step S23.

The GPU is a device that generally does not guarantee a latency, but is suitable for increasing throughput by the parallel processing. Typical examples include encryption processing, image processing for camera video analysis, and machine learning processing for analyzing large amounts of sensor data, which often involve repeated processing. Therefore, it is aimed to speed up the application by automatically offloading repetition statements to the GPU.

However, as described in the prior art, appropriate parallel processing is required to increase speed. In particular, when using a GPU, performance is often not achieved unless the data size and loop count are large due to memory transfer between the CPU and GPU. Furthermore, depending on the timing of memory data transfer and the like, there are cases where the combination of individual loop statements (repetition statements) that can be accelerated in parallel may not be the fastest. For example, if there are ten for statements (repetition statements), and if three for statements corresponding to the numbers 1, 5, and 10 can be made faster than the CPU, it cannot be said that the combination of the three for statements corresponding to the numbers 1, 5, and 10 will be the fastest.

In order to specify an appropriate parallel area, there is an attempt to optimize the parallelism of for statements through trial and error using the PGI compiler. However, many operations are required for the trial and error, and there is a problem that the start of use by the user is delayed and the cost is increased when providing the service.

Therefore, in the present embodiment, an appropriate offload area is automatically extracted from a general-purpose program which is not assumed to be parallelized. For this reason, it is first checked for parallelizable for statements, and then performance verification attempts are repeated in a verification environment using GA for the group of parallelizable for statements to search for an appropriate area. By narrowing down to for statements that can be parallelized, and then retaining and recombining parallel processing patterns that can be sped up in the form of genetic parts, it is possible to search for patterns that can be efficiently sped up from a huge number of possible parallel processing patterns.

### [Search Image of Control Unit (Automatic Offload Function Unit) 11 Using Simple GA]

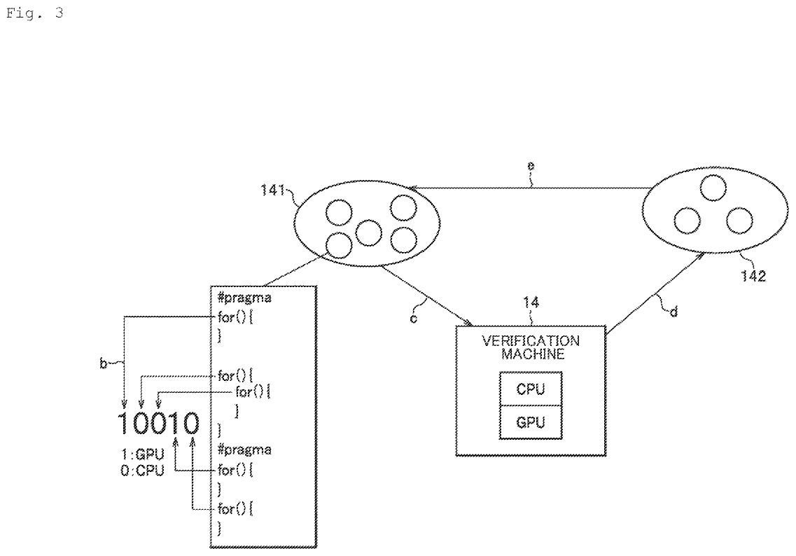

FIG. 3 is a diagram showing a search image of the control unit (automatic offload function unit) 11 using simple GA. FIG. 3 shows a search image of processing and the gene sequence mapping of for statements.

GA is a combinatorial optimization method that mimics the evolutionary process of living organisms. The flowchart of GA is initialization→evaluation→selection→crossover→mutation→termination determination.

In the present embodiment, among the GAs, a simple GA with simplified processing is used. Simple GA is a simplified GA in which the genes are only 1 and 0, and roulette selection, one-point crossover, and mutation reverse the value of one gene.

### <Initialization>

During initialization, after checking whether all for statements in the application code can be parallelized, the for statements that can be parallelized are mapped to gene sequences. When the GPU processing is performed, it is set to 1, and when the GPU processing is not performed, it is set to 0. A specified number M of genes are prepared, and 1 or 0 is randomly assigned to one for statement.

Specifically, the control unit (automatic offload function unit) 11 (see FIG. 1) obtains the application code 125 (see FIG. 2) used by the user, and checks whether the for statements can be parallelized from the code pattern 141 of the application code 125 (see FIG. 2) as shown in FIG. 3. As shown in FIG. 3, if five for statements are found from the code pattern 141 (see symbol b in FIG. 3), one digit of 1 or 0 is randomly assigned to each for statement. In this example, five digits of 1 or 0 are randomly assigned to five for statements. For example, it is set to 0 if it is processed by the CPU, and 1 if it is sent to the GPU. However, at this stage, 1 or 0 is randomly assigned.

The code corresponding to the gene length is 5 digits, and a code with the 5-digit gene length has 32 patterns (25=32), for example, 10001, 10010, and the like. Note that in FIG. 3, circles (O marks) in the code pattern 141 are shown as images of codes.

### <Evaluation>

In the evaluation, deployment and performance measurement are performed (see symbol c in FIG. 3). That is, the performance measuring unit 118 (see FIG. 1) compiles the code corresponding to the gene, deploys it to the verification machine 14, and executes it. The performance measuring unit 118 performs benchmark performance measurement. The fitness of genes for patterns with good performance (parallel processing patterns) is increased.

### <Selection>

In the selection, high-performance code patterns are selected based on the fitness (see symbol d in FIG. 3). The performance measuring unit 118 (see FIG. 1) selects a specified number of genes with high fitness based on the fitness. In the present embodiment, roulette selection and elite selection of the highest fitness gene are performed according to the fitness.

In FIG. 3, the search image shows that the number of circles (O marks) in the selected code patterns (select code patterns) 142 has been reduced to three.

### <Crossover>

In the crossover, a part of genes is exchanged at a certain one point between selected genes at a fixed crossover rate Pc to prepare child genes.

The genes of a certain pattern (a parallel processing pattern) and other patterns selected by the roulette are crossed. The position of the one-point crossover is arbitrary; for example, the crossover is made at the third digit of the five-digit code.

### <Mutation>

In the mutation, each value of the individual gene is changed from 0 to 1 or from 1 to 0 at a constant mutation rate Pm.

In addition, mutations are introduced to avoid local solutions. Note that the mutation may not be performed in order to reduce the operation amount.

### <Termination Judgment>

As shown in FIG. 3, generation of next generation code patterns after crossover & mutation is performed (see symbol e in FIG. 3).

In the termination judgement, the processing is terminated after repeating the specified number of generations T times, and the gene having the highest fitness is made a solution. For example, the performance is measured and the three fastest patterns 10010, 01001, and 00101 are selected. Using GA, these three patterns are recombined in the next generation, for example, by crossing the first and second patterns to create a new pattern (parallel processing pattern) 11011. At this time, mutations such as arbitrarily changing 0 to 1 are added to the recombined pattern. Repeat the above to find the fastest pattern. A specified generation (for example, 20 generations) is determined, and the pattern remaining in the final generation is set as the final solution.

### <Deployment>

The parallel processing pattern with the highest processing performance corresponding to the gene with the highest fitness is newly deployed to the production environment and provided to the user.

### <Supplementary Explanation>

The case where there are a considerable number of for statements (loop statements; repetition statements) that cannot be offloaded to the GPU will be described For example, even if there are 200 for statements, only about thirty for statements can be offloaded to the GPU. Here, those that cause errors are excluded and GA is performed on these thirty for statements.

OpenACC has a compiler that can be specified with the directive #pragma acc kernels to extract GPU-specific bytecode and execute it to enable GPU offloading. By writing a for statement command in this #pragma, it is possible to determine whether the for statement runs on the GPU.

For example, if C/C++ is used, the C/C++ code is analyzed to find for statements. When a for statement is found, OpenACC uses parallel processing syntax such as #pragma acc kernels, #prama acc parallel loop, or #prama acc parallel loop vector to write to the for statement. In detail, each for statement is inserted in #pragma acc kernels, #prama acc parallel loop, or #prama acc parallel loop vector and compiled. If there is an error, the for statement cannot be processed by the GPU in the first place. Therefore, the for statement is excluded.

In this way, the remaining for statements are found. Then, the length (gene length) is defined as the length of the for statement without any error. If there are five error-free for statements, the gene length is 5. If there are ten error-free for statements, the gene length is 10. Note that the for statement which cannot be processed in parallel is dependent on the data in which the preceding processing is used for the next processing.

The above is the preparation stage. Next, GA processing is performed.

A code pattern with a gene length corresponding to the number of for statements is obtained. At first, parallel processing patterns 10010, 01001, 00101, and the like are randomly assigned. GA processing is performed and compiling is performed. At that time, an error may occur even though the for statement can be offloaded. This is the case when the for statements are hierarchical (specifying either one allows GPU processing). In this case, the for statement that caused the error may be retained. More specifically, there is a method of time-out in a form of increasing the processing time.

The code patterns are deployed in the verification machine 14, and are benchmarked. For example, if it is image processing, it is benchmarked with image processing. The shorter the processing time, the higher the fitness is evaluated. For example, in the −½ power of processing time, if the processing time is 1 second, it is 1, if it takes 100 seconds, it is 0.1, and if it takes 0.01 seconds, it is 10.

Those with high fitness are selected, for example, 3 to 5 out of ten code patterns are selected, and are rearranged to create a new code pattern. At this time, the same thing as before may be created during creation. In that case, there is no need to run the same benchmark, so the same data as before is used. In the present embodiment, the code pattern and its processing time are stored in the storage unit 13.

The above describes the search image of the control unit (automatic offload function unit) 11 using simple GA. Next, a batch processing method for data transfer will be described.

### [Batch Processing Method for Data Transfer]

### <Basic Concept>

In order to reduce CPU-GPU transfers, in addition to transferring nested loop variables as high as possible, the present invention batches the transfer timings of many variables and further reduces transfers that are automatically transferred by the compiler.

In order to reduce transfers, variables whose timing of transfer to the GPU can be summarized are transferred not only in nest units, but also in batches. For example, if the variable is not a variable that processes the GPU processing result using the CPU and then processes it again using the GPU, variables defined on the CPU that are used in multiple loop statements may be transferred to the GPU in batches before GPU processing starts, and be returned to the CPU after all GPU processing is completed.

In order to understand the reference relationships of loops and variables during code analysis, based on the analysis result, the data copy statement of OpenACC is used to specify that GPU processing and CPU processing are not nested for variables defined in multiple files and variables for which CPU processing and GPU processing are separated are to be transferred in batches.

Variables that are transferred in batches before the start of GPU processing and do not need to be transferred at the timing of loop statement processing are specified that they do not need to be transferred using data present.

When transferring data between CPU and GPU, a temporary area (#pragma acc declare create) is created and data is stored in the temporary area, and then the transfer is instructed by synchronizing the temporary area (#pragma acc update).

### Comparative Example

First, a comparative example will be described.

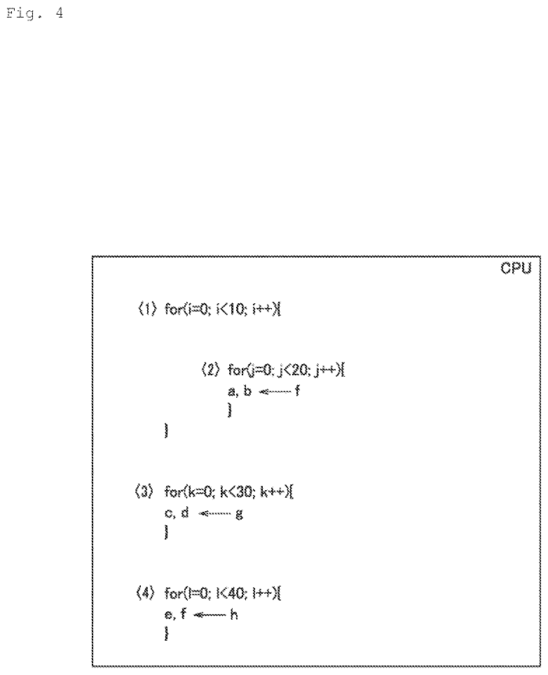

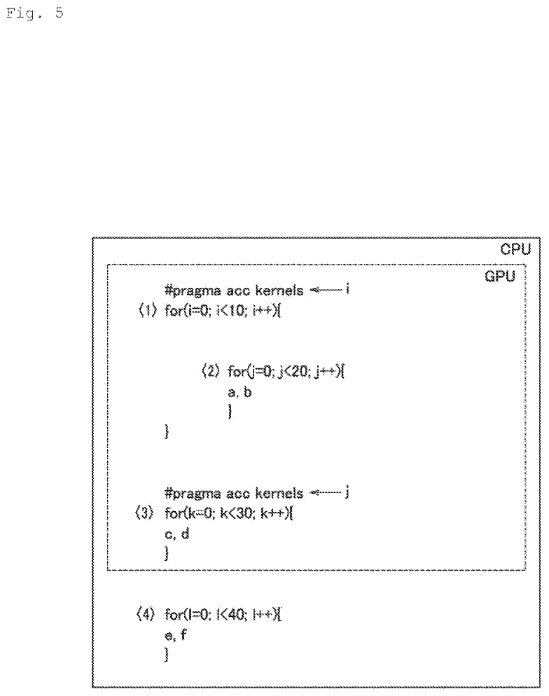

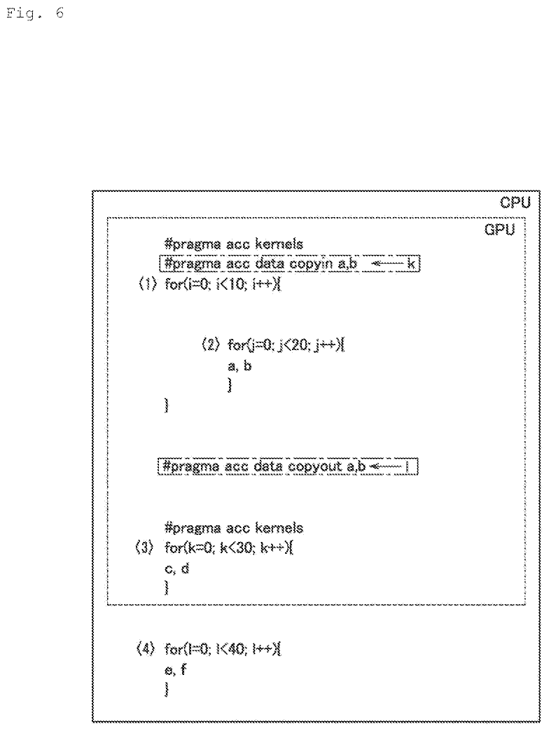

Comparative examples include a normal CPU program (see FIG. 4), simple GPU usage (see FIG. 5), and nested batching (NPL 2) (see FIG. 6). Note that <1> to <4> and the like at the beginning of the loop statements in the following description and figures are added for convenience of explanation (the same applies to other figures and their explanations).

The loop statement of the normal CPU program shown in FIG. 4 is written on the CPU program side.

The loop <2> [for(j=0; j<20; j++]{is present inside the loop <1> [for(i=0; i<10; i++)]{ }.

Symbol f in FIG. 4 is the setting of variables a and b in the loop <2>.

In addition, the loop <3> [for(k=0; k<30; k++)]{ } and the loop <4> [for (1=0; 1<40; 1++)]{ } follow.

Symbol g in FIG. 4 is the setting of variables c and d in the loop <3>, and symbol h in FIG. 4 is the setting of variables e and f in the loop <4>.

The normal CPU program shown in FIG. 4 is executed on the CPU (GPU is not used).

FIG. 5 is a diagram showing a loop statement when the normal CPU program shown in FIG. 4 is used to transfer data from the CPU to the GPU using a simple GPU. Types of data transfer include data transfer from the CPU to the GPU, and data transfer from the GPU to the CPU. Below, data transfer from the CPU to the GPU will be taken as an example.

The simple GPU-using loop statement shown in FIG. 5 is written on the CPU program side.

The loop <2> [for(j=0; j<20; j++]{is present inside the loop <1> [for(i=0; i<10; i++)]{ }.

Furthermore, as indicated by symbol i in FIG. 5, it is specified at the top of the loop <1> [for(i=0; i<10; i++)]{ } using the OpenACC directive #pragma acc kernels (parallel processing specifying statement) that the PGI compiler can process a parallel processable processing unit such as a for statement.

As shown in the dashed line box containing symbol i in FIG. 5, data is transferred from the CPU to the GPU by #pragma acc kernels. Here, a and b are transferred at this timing, so they are transferred 10 times.

In addition, as indicated by symbol j in FIG. 5, it is specified at the top of the loop <3> [for(k=0; k<30; k++)]{ } using the OpenACC directive #pragma acc kernels that the PGI compiler can process a parallel processable processing unit such as a for statement.

As shown in the dashed line box containing symbol j in FIG. 5, c and d are transferred at this timing by #pragma acc kernels.

Here, #pragma acc kernels is not specified at the top of the loop <4> [for(l=0; l<40; l++)]{ }.

This loop is not processed by the GPU because it is inefficient even if it is processed by the GPU.

FIG. 6 is a diagram showing a loop statement when data is transferred from the CPU to the GPU and from the GPU to the CPU using nest batching (NPL 2).

In the loop statement shown in FIG. 6, the data transfer instruction line from the CPU to the GPU, here, #pragma acc data copyin(a,b) of the copyin clause for variables a and b, is inserted at the position indicated by symbol k in FIG. 6. Note that in this specification, parentheses ( ) are added to copyin(a,b) for convenience of notation. A similar notation method is used for copyout(a,b) and datacopyin(a,b,c,d), which will be described later.

The #pragma acc data copyin(a,b) is specified in the top-level loop that does not include the setting or definition of variable a (here, at the top of the loop <1> [for(i=0; i<10; i++)]{ }).

Since a and b are transferred at the timing shown in the dashed-dotted line frame including symbol k in FIG. 6, one transfer occurs.

In addition, in the loop statement shown in FIG. 6, a data transfer instruction line from the GPU to the CPU, here, #pragma acc data copyout(a,b) in the copyout clause of variables a and b, is inserted at the position indicated by symbol l in FIG. 6.

The #pragma acc data copyout(a,b) is specified at the bottom of the loop <1> [for(i=0; i<10; i++)]{ }.

In this way, in data transfer from the CPU to the GPU, data transfer is explicitly instructed by inserting #pragma acc data copyin(a,b) in the copyin clause of variable a at the above-mentioned position. As a result, data can be transferred in batches in a loop as high as possible, and inefficient transfers such as the simple GPU-using loop statement shown in FIG. 5, where data is transferred every time in each loop, can be avoided.

### Embodiment

Next, the present embodiment will be described.

<<Use Data Present to Clearly Indicate Variables that do not Need to be Transferred>>

In the present embodiment, the data copy statement of OpenACC is used to specify that GPU processing and CPU processing are not nested for variables defined in multiple files and variables for which CPU processing and GPU processing are separated are to be transferred in batches. In addition, variables that are transferred in batches and do not need to be transferred at that timing are specified using data present.

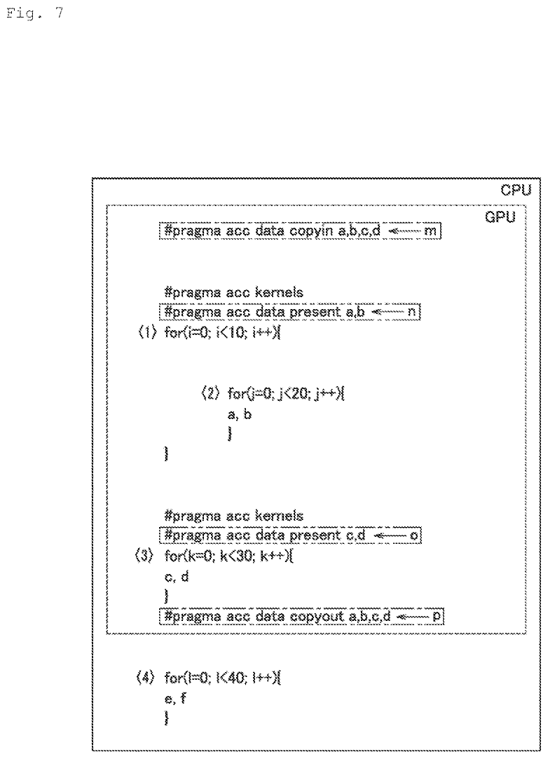

FIG. 7 is a diagram showing a loop statement based on transfer batching during data transfer between the CPU and GPU of the present embodiment. FIG. 7 corresponds to the nest batching shown in FIG. 6 as a comparative example.

In the loop statement shown in FIG. 7, a data transfer instruction line from the CPU to the GPU, here, #pragma acc datacopyin(a,b,c,d) of the copyin clause of variables a, b, c, and d, is inserted at the position indicated by symbol m in FIG. 7.

The #pragma acc data copyin(a,b,c,d) is specified in the top-level loop that does not include the setting or definition of variable a (here, at the top of the loop <1> [for(i=0; i<10; i++)]{ }).

In this way, OpenACC's data copy statement #pragma acc data copyin(a,b,c,d) is used to specify that GPU processing and CPU processing are not nested for variables defined in multiple files and variables for which CPU processing and GPU processing are separated are to be transferred in batches. Since a, b, c, and d are transferred at the timing shown in the dashed-dotted line frame including symbol m in FIG. 7, one transfer occurs.

the data present statement #pragma acc data present (a,b) is used to specify that variables that are transferred in batches using #pragma acc data copyin(a,b,c,d) and that do not need to be transferred at that timing already exist on the GPU at the timing indicated by the double-dashed chain line frame containing symbol n in FIG. 7.

The data present statement #pragma acc data present(c,d) is used to specify that variables that are transferred in batches using #pragma acc data copyin(a,b,c,d) and do not need to be transferred at that timing already exist on the GPU at the timing indicated by the double-dashed chain line frame containing symbol o in FIG. 7.

A data transfer instruction line for transfer from the GPU to the CPU at the timing at which the loops <1> and <3> are processed by the GPU and the GPU processing is finished, here, #pragma acc datacopyout(a,b,c,d) of the copyout clause of variables a, b, c, d, is inserted at the position p where the loop <3> in FIG. 7 ends.

By specifying that variables that can be transferred in batches are to be transferred in batches by specifying batch transfer, and variables that have already been transferred do not need to be transferred using data present, it is possible to reduce transfers and further improve the efficiency of offloading methods. However, depending on the compiler, the compiler may automatically make a decision and transfer files even if OpenACC is used to instruct the transfer. Automatic transfer by the compiler is a phenomenon in which, unlike the instructions of OpenACC, transfer between the CPU and GPU is not originally necessary but is automatically transferred depending on the compiler.

### <<Temporary Storage of Data>>

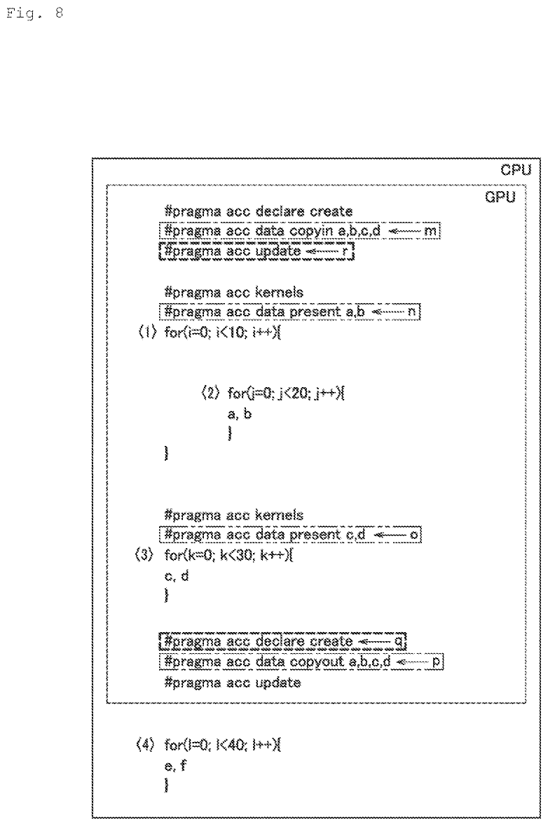

FIG. 8 is a diagram showing a loop statement based on transfer batching during data transfer between the CPU and GPU of the present embodiment. FIG. 8 corresponds to the nested batching and the specification of variables that do not need to be transferred in FIG. 7.

In the loop statement shown in FIG. 8, the OpenACC declare create statement #pragma acc declare create, which creates a temporary area during CPU-GPU data transfer, is specified at the position indicated by symbol q in FIG. 8. As a result, when transferring data between CPU and GPU, a temporary area is created (#pragma acc declare create) and data is stored in the temporary area.

In addition, the transfer is instructed by specifying the OpenACC declare create statement #pragma acc update for synchronizing the temporary area at the position indicated by symbol r in FIG. 8.

In this way, by creating a temporary area, initializing parameters in the temporary area, and using it for CPU-GPU transfers, unnecessary CPU-GPU transfers are blocked. OpenACC instructions can reduce unintended transfers that degrade performance.

### [GPU Offload Processing]

By using the above-mentioned data transfer batch processing method, it is possible to extract a loop statement suitable for offloading and avoid inefficient data transfer.

However, even if the data transfer batch processing method is used, there are some programs that are not suitable for GPU offloading. Effective GPU offloading requires that the loop count of the offloaded processing is large.

Therefore, in the present embodiment, as a preliminary step to searching for full-scale offload processing, a profiling tool is used to investigate the loop count. By using a profiling tool, it is possible to check the number of times each line is executed. Thus, for example, programs with 50 million or more loops can be sorted in advance as targets for offload processing search. A detailed explanation will be given below (some of the contents overlap with those described in FIG. 2).

In the present embodiment, first, the application code analysis unit 112 (FIG. 1) analyzes the application and identifies loop statements such as for, do, and while. Next, sample processing is executed, and a profiling tool is used to investigate the loop count in each loop statement. It is determined whether to perform a full-scale search based on whether there is a loop statement with loops exceeding a certain value.

If it is determined to conduct a full-scale search, GA processing begins (see FIG. 2). In the initialization step, after checking whether all loop statements in the application code can be parallelized, the loop statements are mapped to a gene sequence such that 1 is set when a parallelizable loop statement is processed by the GPU and otherwise 0 is set. A specified number of genes are prepared, and each value of the gene is randomly assigned a value of 1 or 0.

Here, in the code corresponding to the gene, an explicit instruction for data transfer (#pragma acc data copyin/copyout/copy) is added from the variable data reference relationship in the loop statement specified for GPU processing.

In the evaluation step, the code corresponding to the gene is compiled, deployed to a verification machine and executed, and benchmark performance is measured. Then, the fitness of genes with good performance patterns is increased. As mentioned above, the parallel processing instruction line (for example, see symbol f in FIG. 4) and the data transfer instruction line (for example, see symbol h in FIG. 4, symbol i in FIG. 5, and symbol k in FIG. 6) are inserted in the code corresponding to the gene.

In the selection step, a specified number of genes with high fitness are selected based on the fitness. In the present embodiment, roulette selection and elite selection of the highest fitness gene are performed according to the fitness. In the crossover step, some genes are exchanged at a certain point between the selected genes at a constant crossover rate Pc to create child genes. In the mutation step, each value of the individual gene is changed from 0 to 1 or from 1 to 0 at a constant mutation rate Pm.

Once the mutation step has been completed and a specified number of next generation genes have been created, an explicit instruction for data transfer is added in the same way as the initialization step, and the evaluation, selection, crossover, and mutation steps are repeated.

Finally, in the termination determination step, the processing is terminated after repeating the specified number of generations, and the gene with the highest fitness is determined as the solution. The code pattern with the highest performance corresponding to the gene with the highest fitness is redeployed to the production environment and provided to the user.

The implementation of the offload server 1 will be described below. This implementation is for confirming the effectiveness of the present embodiment.

### [Implementation]

The implementation of automatic offloading of C/C++applications using the general-purpose PGI compiler will be explained.

Since the purpose of this implementation is to confirm the effectiveness of GPU automatic offloading, the target application is a C/C++ language application, and the conventional PGI compiler is used to explain the GPU processing itself.

The C/C++ language is highly popular in the development of OSS (Open Source Software) and proprietary software, and many applications are developed using the C/C++ language. In order to confirm the offloading of applications used by general users, general-purpose OSS applications such as cryptographic processing and image processing will be used.

GPU processing is performed by the PGI compiler. The PGI compiler is a C/C++/Fortran compiler that interprets OpenACC. In the present embodiment, parallelizable processing units such as for statements are specified using the OpenACC directive #pragma acc kernels (parallel processing specifying statement). This enables GPU offloading by extracting GPU bytecode and executing it. Furthermore, an error will be generated if pieces of data in the for statement are dependent on each other and cannot be processed in parallel, or if multiple different levels of nested for statements are specified. In addition, directives such as #pragma acc data copyin/copyout/copy enable explicit data transfer instructions.

In accordance with the specification in #pragma acc kernels (parallel processing specifying statement), an explicit data transfer instruction is performed by inserting #pragma acc data copyout(a[ . . . ]) in the copyin clause of OpenACC in the above-mentioned position.

### <Implementation Operation Overview>

An overview of the implementation operation will be explained. The implementation performs the following processing.

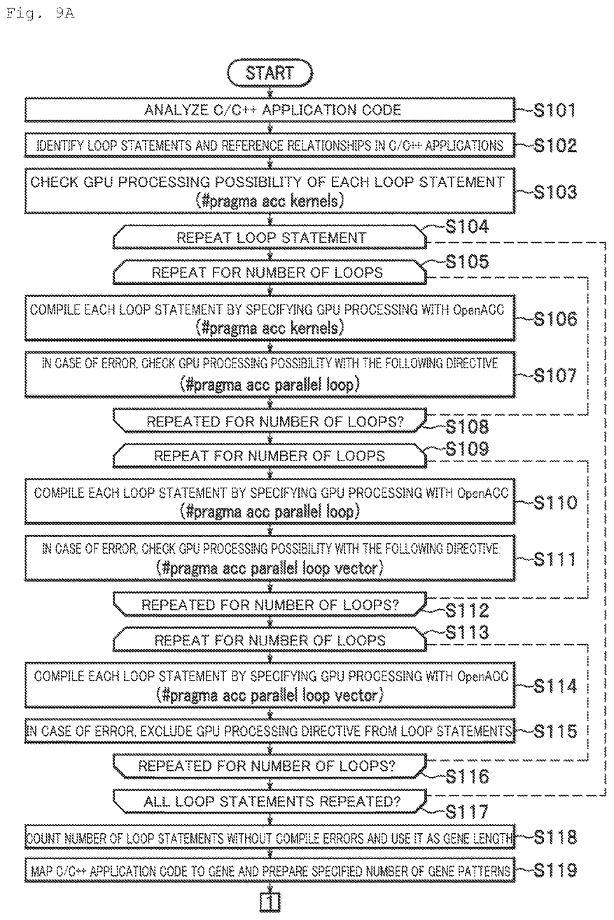

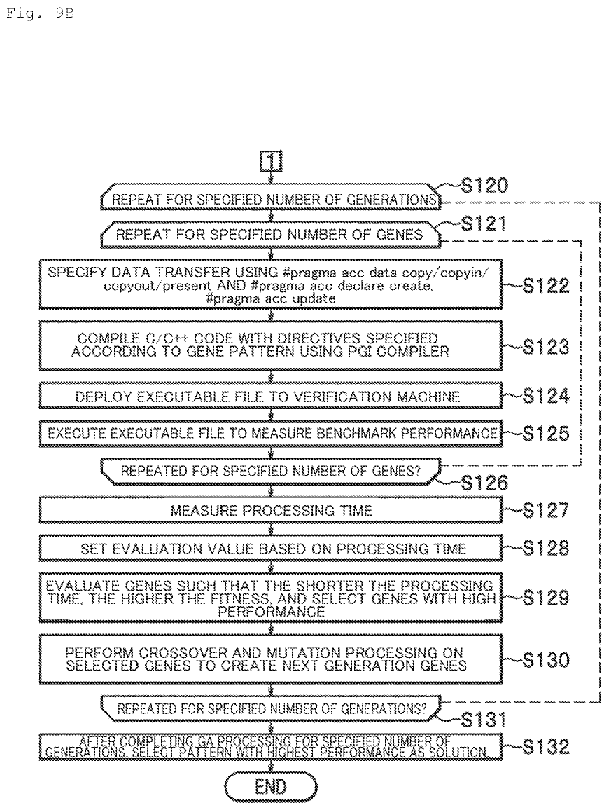

Before starting the processing of the flow shown in FIGS. 9A and 9B below, the C/C++ application to be accelerated and a benchmark tool to measure its performance are prepared.

In implementation, when a request to use a C/C++ application is received, first the code of the C/C++ application is analyzed to discover for statements and understand the program structure, such as variable data used within the for statement. For syntax analysis, the LLVM/Clang syntax analysis library is used.

In the implementation, first, in order to get an idea of whether the application has a GPU offloading effect, a benchmark is run to find out the loop count in the for statement found in the syntax analysis. To understand the loop count, GNU Coverage's gcov and the like are used. “GNU Profiler (gprof)” and “GNU Coverage (gcov)” are known as profiling tools. Either can be used because both can check the number of times each line is executed. For example, the number of executions can be set to target only applications that have a loop count of 10 million times or more, but this value can be changed.

General-purpose CPU applications are not implemented for the purpose of parallelization. Therefore, first of all, it is necessary to eliminate for statements that cannot be processed by the GPU. Therefore, for each for statement, directives such as #pragma acc kernels, #prama acc parallel loop, or #prama acc parallel loop vector for GPU processing are inserted, and whether an error occurs during compiling is determined. There are several types of compile errors. There are cases where an external routine is called in a for statement, different layers are specified repeatedly in a nested for statement, there is processing such as break that exits the for statement midway, or there is a data dependency in the data of the for statement. The types of compile errors vary depending on the application, and there may be other cases, but compile errors are not handled and #pragma directives are not inserted.

Compile errors are difficult to deal with automatically, and even if they are dealt with, they are often ineffective. In the case of an external routine call, it may be possible to avoid it by using #pragma acc routine. However, many external calls are libraries, and even if GPU processing is performed including this, the call will become a bottleneck and performance will not be achieved. Since each for statement is tried one by one, no compile errors occur regarding nesting errors. In addition, if the program exits midway due to a break and the like, the loop count must be fixed for parallel processing, and the program must be modified. If there is data dependence, parallel processing itself cannot be performed in the first place.

Here, if the number of loop statements that do not cause an error even when processed in parallel is a, then a is the gene length. The application code is mapped to the gene of length a such that 1 of the gene corresponds to the presence of a parallel processing directive and 0 corresponds to no parallel processing directive.

Next, a specified number of gene sequences are prepared as initial values. Each gene value is created by randomly assigning 0 and 1 as explained in FIG. 3. Depending on the prepared gene sequence, if the gene value is 1, the directives specifying the GPU processing such as \#pragma acc kernels, \#pragma acc parallel loop, or \#pragma acc parallel loop vector are inserted into the C/C++ code. The reason why single loops are not parallelized is that kernels have better performance as a PGI compiler for the same processing. At this stage, it is determined which part of the code corresponding to a particular gene will be processed by the GPU.

The C/C++ code with parallel processing and data transfer directives inserted is compiled using a PGI compiler on a machine equipped with a GPU. The compiled executable file is deployed and performance and power usage are measured with benchmark tools.

After benchmark performance is measured for all gene sequences, the fitness of each gene sequence is set according to the benchmark processing time and power consumption. Gene sequences to be retained are selected according to the set fitness. The selected gene sequences are subjected to GA processing including crossover processing, mutation processing, and direct copy processing to create the next generation gene sequences.

Directive insertion, compiling, performance measurement, fitness setting, selection, crossover, and mutation processing are performed on the next generation gene sequences. Here, if a gene with the same pattern as before is generated during the GA processing, no compiling or performance measurement is performed for that gene, and the same measurement value as before is used.

After completing GA processing for the specified number of generations, the C/C++ code with directives corresponding to the gene sequence with the highest performance is taken as the solution.

Among these, the number of genes, number of generations, crossover rate, mutation rate, fitness setting, and selection method are GA parameters and are specified separately. By automating the above processing, the proposed technology makes it possible to automate GPU offloading, which previously required the time and skills of specialized engineers.

FIGS. 9A and 9B are flowcharts showing an overview of the operation of the implementation described above, and FIGS. 9A and 9B are connected by a connector.

The following processing is performed using the OpenACC compiler for C/C++.

### <Code Analysis>

In step S101, the application code analysis unit 112 (see FIG. 1) performs code analysis of the C/C++ application.

### <Loop Statement Identification>

In step S102, the parallel processing specifying unit 114 (see FIG. 1) identifies loop statements and reference relationships of the C/C++ application.

### <Parallel Processing Possibility of Loop Statements>

In step S103, the parallel processing specifying unit 114 checks the GPU processing possibility of each loop statement (#pragma acc kernels).

### <Repetition of Loop Statement>

The control unit (automatic offload function unit) 11 repeats the processing of steps S105 to S116 by the number of loop statements between the loop start end of step S104 and the loop end of step S117.

### <Repetition for Number of Loops (Part 1)>

The control unit (automatic offload function unit) 11 repeats the processing of steps S106 to S107 by the number of loop statements between the loop start end of step S105 and the loop end of step S108.

In step S106, the parallel processing specifying unit 114 specifies GPU processing (#pragma acc kernels) using OpenACC and compiles each loop statement.

In step S107, in the event of an error, the parallel processing specifying unit 114 checks the possibility of GPU processing using the following directive (#pragma acc parallel loop).

### <Repetition for Number of Loops (Part 2)>

The control unit (automatic offload function unit) 11 repeats the processing of steps S110 to S111 by the number of loop statements between the loop start end of step S109 and the loop end of step 3112.

In step S110, the parallel processing specifying unit 114 specifies GPU processing (#pragma acc parallel loop) with OpenACC and compiles each loop statement.

In step 3111, in the event of an error, the parallel processing specifying unit 114 checks the possibility of GPU processing using the following directive (#pragma acc parallel loop vector).

### <Repetition for Number of Loops (Part 3)>

The control unit (automatic offload function unit) 11 repeats the processing of steps S114 to S115 by the number of loop statements between the loop start end of step S113 and the loop end of step S116.

In step S114, the parallel processing specifying unit 114 specifies GPU processing (#pragma acc parallel loop vector) with OpenACC and compiles each loop statement.

In step S115, the parallel processing specifying unit 114 removes the GPU processing directive from the loop statement in the event of an error.

### <Count Number of for Statements>

In step S118, the parallel processing specifying unit 114 counts the number of loop statements (here, for statements) that do not cause a compile error, and sets the number as the gene length.

### <Preparation of Specified Number of Gene Patterns>

Next, as an initial value, the parallel processing specifying unit 114 prepares a specified number of gene sequences. Here, 0 and 1 are randomly assigned to create gene sequences.

In step S119, the parallel processing specifying unit 114 maps the C/C++ application code to genes and prepares a specified number of gene patterns.

Depending on the prepared gene sequence, a directive that specifies parallel processing if the gene value is 1 is inserted into the C/C++ code (for example, see #pragma directive in FIG. 3).

The control unit (automatic offload function unit) 11 repeats the processing of steps S121 to S130a for a specified number of generations between the loop start end of step S120 and the loop end of step S131 in FIG. 9B.

In addition, in the repetition for the specified number of generations, the processing of steps S122 to 3125 is further repeated for a specified number of genes between the loop start end of step S121 and the loop end of step S126. That is, within the repetition for the specified number of generations, the repetition for the specified number of genes is processed in a nested state.

### <Data Transfer Specification>

In step S122, the data transfer specifying unit 113 specifies data transfers using explicit instruction lines (#pragma acc data copy/copyin/copyout/present and #pragma acc declare create, or #pragma acc update) based on the variable reference relationship.

### <Compile>

In step S123, the parallel processing pattern creation unit 117 (see FIG. 1) uses the PGI compiler to compile the C/C++ code specified by the directive according to the gene pattern. That is, the parallel processing pattern creation unit 117 compiles the created C/C++ code using the PGI compiler on the verification machine 14 equipped with a GPU.

A compile error may occur if multiple nested for statements are specified in parallel. In this case, the compiling error is handled in the same manner as in the case where the processing time for measuring the performance has expired.

In step S124, the performance measuring unit 118 (see FIG. 1) deploys the executable file to the verification machine 14 equipped with a CPU-GPU.

In step S125, the performance measuring unit 118 executes the deployed binary file and measures the benchmark performance when offloaded.

In the middle generation, the same value is used for the genes having the same pattern as before without measuring the performance. In other words, if a gene with the same pattern as before occurs during GA processing, no compiling or performance measurement is performed for that gene, and the same measurement values as before are used.

In step S127, the performance measuring unit 118 (see FIG. 1) measures processing time.

In step S128, the performance measuring unit 118 sets an evaluation value based on the measured processing time.

In step S129, the executable file creation unit 119 (see FIG. 1) evaluates genes such that the shorter the processing time, the higher the fitness, and selects genes with higher performance. The executable file creation unit 119 selects a pattern with a short processing time and low power consumption as a solution from among the plurality of measured patterns.

In step S130, the executable file creation unit 119 performs crossover and mutation processing on the selected gene to create the next generation gene. The executable file creation unit 119 performs compiling, performance measurement, fitness setting, selection, crossover, and mutation processing on the next generation gene.

That is, after benchmark performance is measured for all genes, the fitness of each gene sequence is set according to the benchmark processing time. Gene sequences to be retained are selected according to the set fitness. The executable file creation unit 119 performs GA processing such as crossover processing, mutation processing, and direct copy processing on the selected genes to create next generation gene sequences.

In step S132, after completing the GA processing for the specified number of generations, the executable file creation unit 119 sets the C/C++ code (parallel processing pattern with the highest performance) corresponding to the gene sequence with the highest performance as a solution.

### <GA Parameters>

The above-mentioned number of genes, number of generations, crossover rate, mutation rate, fitness setting, and selection method are GA parameters. The GA parameters may be set as follows, for example.

For example, the parameters and conditions of Simple GA to be executed can be as follows.
Gene length: number of loop statements that can be parallelized
Number of genes M: less than or equal to gene length
Number of generations T: less than or equal to gene length
Fitness: (processing time)^{(-1/2)}

With this setting, the shorter the benchmark processing time, the higher the fitness. In addition, by setting the fitness to the (−½) power of the processing time, it is possible to prevent the search range from narrowing due to the fitness of a specific gene with a short processing time becoming too high. Furthermore, if the performance measurement does not end within a certain period of time, it is timed out and the fitness is calculated assuming that the processing time is a long time such as 1000 seconds. This timeout period may be changed depending on performance measurement characteristics.

### Selection: Roulette Selection

However, elite conservation is also performed in which genes with the highest fitness in a generation are preserved in the next generation without crossover or mutation.
Crossover rate Pc: 0.9
Mutation rate Pm: 0.05

### <Cost Performance>

The cost performance of automatic offloading functions will be described.

Looking only at the price of GPU board hardware such as NVIDIA Tesla, the price of a machine equipped with a GPU is about twice that of a regular CPU-only machine. However, in general, as for the cost of data centers and the like, the cost of hardware and system development is ⅓ or less, the operating cost such as electricity bills, maintenance and operation system is more than ⅓, and the other cost such as service orders is about ⅓. In the present embodiment, the performance of time-consuming processing in applications such as cryptographic processing and image processing can be doubled or more. Therefore, even if the server hardware price itself doubles, cost effectiveness can be expected.

In the present embodiment, using gcov, gprof, and the like, applications that have many loops and take a long execution time are identified in advance, and an offload attempt is performed. In this way, it is possible to find applications that can be efficiently accelerated.

### <Time Taken to Start Using Actual Service>

The time taken to start using the actual service will be described.

Assuming that it takes about 3 minutes to perform one performance measurement after compiling, it will take a maximum of about 20 hours to search for a solution with a GA with 20 genes and 20 generations. However, since the compiling and measurement of the same genetic pattern as before is omitted, it will take 8 hours or less. In reality, with many cloud, hosting, and network services, it takes about half a day to start using the service. In the present embodiment, automatic offloading can be performed within half a day, for example. Therefore, if automatic offloading is available for less than half a day and users may try the service at first, it is expected that user satisfaction level will be sufficiently increased.

In order to search the offload part in a shorter time, it is possible to measure the performance of each gene in parallel using multiple verification machines. Adjusting the timeout period depending on the application also leads to a shorter processing time. For example, if offload processing takes twice as long as the execution time on the CPU, it may be set as a timeout. Furthermore, the greater the number of genes and generations, the greater the possibility of finding a high-performance solution. However, in order to maximize each parameter, it is necessary to perform compiling and performance benchmark for the number of genes x the number of generations. Therefore, it takes time to start using the actual service. In the present embodiment, the GA is performed with a small number of genes and generations, but by setting the crossover rate Pc to a high value of 0.9 and searching a wide range, a solution with a certain level of performance can be found quickly.

### [Expansion of Directive Phrase]

In the present embodiment, the directive phrases are expanded in order to increase the number of applicable applications. Specifically, in addition to the kernels directive, directives that specify GPU processing are expanded to include parallel loop directives and parallel loop vector directives.

In the OpenACC standard, kernels are used for single loops and tightly nested loops. Parallel loops are also used for loops, including non-tightly nested loops. A parallel loop vector is used for loops that cannot be parallelized but can be vectorized. Here, a tightly nested loop is a nested loop, and is a simple loop where, for example, when two loops that increment i and j are nested, the lower loop performs processing using i and j, but the upper loop does not use the same. Furthermore, in the implementation of PGI compilers and the like, there is a difference in that with kernels, the compiler makes the decision to parallelize, and with parallel, the programmer makes the decision to parallelize.

Therefore, in the present embodiment, kernels are used for single and tightly nested loops, and parallel loops are used for non-tightly nested loops. In addition, the parallel loop vector is used for loops that cannot be parallelized but can be vectorized.

Here, there is a concern that when the parallel directives are used, the results will be less reliable than in the case of kernels. However, it is assumed that the final offload program will be subjected to a sample test, the difference in results with the CPU will be checked, and the results will be shown to the user for confirmation. In the first place, since CPUs and GPUs have different hardware, there are differences in the number of significant digits and rounding errors, so it is necessary to check the difference in results from the CPU with the kernels alone.

### [Setting of Resource Ratio and Resource Amount and New Application Deployment Flowchart]

FIG. 10 is a flowchart showing the setting of the resource ratio and amount of resources added after a GPU offload attempt, and the deployment of a new application. The flowchart shown in FIG. 10 is executed after the GPU offload attempt shown in FIGS. 9A and 9B.

In step S51, the resource ratio determination unit 115 obtains user operating conditions, test case CPU processing time, and offload device processing time. The user operation conditions are specified by the user when specifying the code that the user wants to offload. The user operating conditions are used by the resource amount setting unit 116 when determining the resource amount by referring to the information in the equipment resource DB 132.

### <Processing of Resource Ratio Determination Unit 115>

In step S52, the resource ratio determination unit 115 determines the ratio of the processing times of the CPU and the offload device (the test case CPU processing time and the offload device processing time) as the resource ratio based on the performance measurement results.

With this automatic offload, performance measurement results have already been obtained in a verification environment during code conversion. Using this performance measurement result, the resource ratio determination unit 115 determines the resource ratio between the CPU and the offload device. Specifically, an appropriate resource ratio is determined based on the ratio of processing time between the CPU and the offload device in the verification environment. For example, if the test case processing time in the verification environment is CPU processing: 10 seconds and GPU processing: 5 seconds, the resource ratio will be CPU:GPU=2:1.

The resource ratio determination unit 115 determines the resource ratio so that the processing times of the CPU and the offload device are on the same order. By determining the resource ratio so that the processing times of the CPU and the offload device are on the same order, the processing times of the CPU and the offload device can be aligned, and the amount of resources can be set appropriately in an environment in which the CPU and the accelerator are present together with GPUs, FPGAs, many-core CPUs, and the like.

If the difference between the processing times of the CPU and the offload device is greater than or equal to a predetermined threshold, the resource ratio determination unit 115 sets the resource ratio to a predetermined upper limit. In other words, if there is a difference of 10 times or more in the processing times of the CPU and the offload device in the verification environment, increasing the resource ratio by 10 times or more will lead to deterioration in cost performance. In this case, the upper limit is set to a resource ratio of 5:1, for example (the upper limit resource ratio is 5:1 of the processing time). By setting an upper limit on the resource ratio, it is possible to prevent the number of VMs from increasing significantly.

### <Processing of Resource Amount Setting Unit 116>

In step S53, the resource amount setting unit 116 sets the resource amount based on the user operating conditions and the appropriate resource ratio. That is, the resource amount setting unit 116 determines the resource amount while keeping the resource ratio as much as possible so as to satisfy the cost condition specified by the user.

The resource amount setting unit 116 maintains an appropriate resource ratio and sets the maximum resource amount that satisfies the user operating conditions. To give a specific example, it is assumed that 1 VM costs 1,000 yen/month for a CPU and 4,000 yen/month for a GPU, and a resource ratio of 2:1 is appropriate, and the user's budget is within 10,000 yen per month. In this case, 2 CPUs and 1 GPU are secured and deployed in a commercial environment.

If the user operating conditions are not satisfied even with the minimum resource amount maintaining the resource ratio, the resource amount setting unit 116 changes the resource ratio and sets the resource amounts of the CPU and the offload device to the minimum so as to satisfy the cost condition. To give a specific example, it is assumed that 1 VM costs 1,000 yen/month for a CPU and 4,000 yen/month for a GPU, and a resource ratio of 2:1 is appropriate, and the user's budget is within 5,000 yen per month. In this case, the resource ratio cannot be maintained because the user budget is insufficient, but the resource amounts of the CPU and offload device are set smaller, that is, 1 CPU and 1 GPU are secured and deployed.

After completing the processing in step S53 and securing and deploying resources in a commercial environment, the automatic verification described in FIG. 2 is executed to confirm performance and cost before users use them. In this way, it is possible to secure resources in a commercial environment and present performance and cost to users after automatic verification.

### <Summary of Resource Ratio and Resource Amount Settings>

In order to optimize the resource ratio, the performance measurement results when determining the offload pattern solution are used. The implementation determines the resource ratio based on the test case processing time so that the CPU and GPU processing times are on the same order. For example, if the test case processing time is 10 seconds for CPU processing and 5 seconds for GPU processing, the resource ratio would be 2:1 because the CPU side resources would be doubled and the processing time would be about the same. Note that the number of virtual machines and the like is an integer, so when calculating the resource ratio from the processing time, it is rounded off to an integer ratio.

Once the resource ratio is determined, the next step is to set the resource amount when deploying the application in a commercial environment. In resource amount determination, the implementation determines the number of VMs and the like by keeping the resource ratio as much as possible to satisfy the cost requirements specified by the user when making an offload request. Specifically, the maximum number of VMs and the like is selected within the cost range while maintaining the resource ratio.

For example, when 1 VM costs 1,000 yen/month for CPU and 4,000 yen/month for GPU, a resource ratio of 2:1 is appropriate, and the user's budget is within 10,000 yen per month, then 2 CPUs and 1 GPU are secured. In addition, if it is not possible to maintain the resource ratio within the cost range, the resource amount is set so that it is as close to the appropriate resource ratio as possible, starting with 1 CPU and 1 GPU. For example, if the budget is less than 5,000 yen per month, it is not possible to maintain the resource ratio, but 1 CPU and 1 GPU are secured.

Once the amount of resources is set, the implementation allocates CPU and GPU resources using the virtualization function of Xen Server, for example.

In step S54, the deployment setting unit 170 uses a linear programming method to calculate and set the deployment location of a new application (APL deployment location) based on the server, link specification information, and existing application deployment information in the equipment resource DB 132.

### [Optimal Deployment of Converted Applications]

When a CPU program is offloaded to a device such as a GPU, the offload server 1 of the present embodiment optimizes the deployment location so that the application meets the user's cost requirements and operates with a short response time.

### <Optimization of Application Deployment Location>

The present embodiment assumes that applications can be deployed not only in the cloud but also at network edges and user edges. However, at the network edge and user edge, servers are less concentrated and more dispersed than in the cloud. Therefore, the cost of computation resources is higher than in the cloud. In other words, although the price of hardware such as CPUs and GPUs is generally the same regardless of the deployment location, in data centers that operate in the cloud, operating costs are relatively low because consolidated servers can be monitored and air-conditioned in batches.

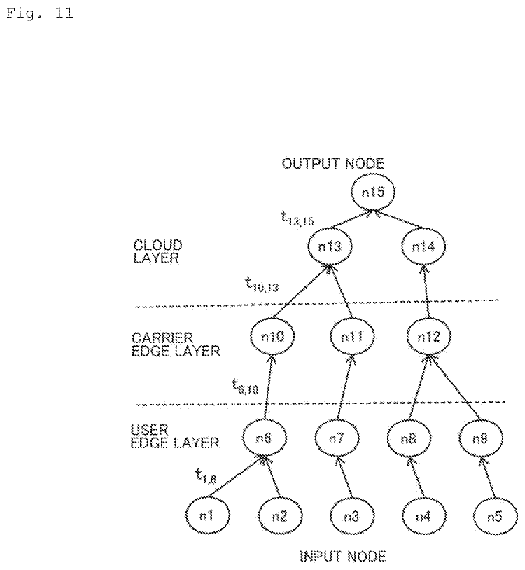

For example, a simple topology of computation node links is shown in FIG. 11.

FIG. 11 is a diagram showing an example of the topology of computation nodes. FIG. 11 shows a topology used, for example, in a situation where, like an IoT system, data is sent from IoT devices that collect data in the user environment to the user edge, then sent to the cloud via the network edge, and the analysis results are viewed and used by company executives.

As shown in FIG. 11, the topology in which the application is deployed consists of three layers, where the number of locations is 2 (n13, n14) for the cloud layer (for example, data center), “3” for the carrier edge layer (for example, central office), “4” (n6 to n9) for the user edge layer (for example, user environment), and “5” (n1 to n5) for the input node.

Assuming applications such as IoT, IoT data (such as pollen sensors and body temperature sensors, which are IoT devices) is collected from input nodes at the user edge, and depending on the characteristics of the application (response time requirements and the like), analytical processing is performed at the user edge and carrier edge, or data is sent to the cloud and then analyzed. The number of locations in the output node is “1” (n15), and the analysis results are viewed by company executives. For example, if the input node is IoT data (pollen sensor), the statistics and analysis results of the output node will be confirmed by the person in charge at the meteorological agency.

The deployment topology with three layers shown in FIG. 11 is an example, and may be five layers, for example. Further, the number of user edges and carrier edges may actually be several tens to several hundreds.

Computation nodes are divided into three types: CPU, GPU, and FPGA. Nodes equipped with GPUs and FPGAs also have CPUs, but using virtualization technology (for example, NVIDIA vGPU), they are divided and provided as GPU instances and FPGA instances, which also include CPU resources.

Applications are deployed in the cloud, at the carrier edge, and at the user edge, and the closer they are to the user environment, the lower the response time, but the higher the cost of computation resources. In the present embodiment, an application converted for GPU or FPGA is deployed, and when deploying, the user can issue two types of requests.

The first is a cost requirement, which specifies the allowable cost of computation resources to run the application, for example, to run it for less than 5,000 yen per month. The second is a response time requirement, which specifies the allowable response time for operating the application, such as returning a response within 10 seconds. In conventional equipment design, for example, locations for deploying servers that accommodate virtual networks are systematically designed by looking at long-term trends such as the amount of traffic increase.

The present embodiment has the following features (1) and (2). (1) The applications to be deployed are not statically determined, but are automatically converted for use with GPUs and FPGAs, and patterns suitable for the usage pattern are extracted through actual measurements using GA or the like Therefore, application code and performance can change dynamically.
(2) It is not only necessary to reduce the carrier's equipment cost and overall response time, but also to satisfy individual user requirements regarding computation resource cost and response time. Additionally, application deployment policies can also change dynamically.

Based on the features (1) and (2) above, application deployment in the present embodiment is performed such that when a user requests deployment, the applications are converted and the converted applications are sequentially deployed to the appropriate server at that time. If the converted application does not improve cost performance, the application deployment before conversion is used. For example, if a GPU instance costs twice as much as a CPU instance, and conversion does not improve performance by more than twice, it is better to deploy the one before conversion. Additionally, if the computation resources and bandwidth have already been used up to their upper limit, it may not be possible to deploy them on that server.

### <Linear Programming Equation for Appropriate Application Deployment>

In the present embodiment, a linear programming method is formulated to calculate an appropriate location for an application. Specifically, the linear programming method uses the parameters of the linear programming equations shown in [Math. 1] (Equations (1) to (4) below) and [Math. 2] (Equations (3) to (6) below).

Here, the cost of devices and links, the upper limit of computation resources, the upper limit of bandwidth, and the like depend on the servers and networks prepared by the operator. Therefore, these parameter values are set in advance by the operator. The amount of computation resources, bandwidth, data capacity, and processing time that an application uses when offloaded are determined by the measurement values of the finally selected offload pattern in a test in the verification environment before automatic conversion and are automatically set by the environment-adaptive function.

The objective function and constraint conditions in the parameters of the linear programming equation change depending on whether the user requirement is a cost requirement for computation resources or a requirement for response time.
Parameters of linear programming equation based on cost requirements

If the cost requirement requires deployment within a month, the parameters of the linear programming equation shown in [Math. 1] below are used.

$$[ Math . 1 ]$$

$${R}_{k} = {\sum }_{i ∈ Device} ( {A}_{i , k}^{d} \cdot {B}_{i , k}^{p} ) + {\sum }_{j ∈ Link} ( {A}_{i , k}^{l} \cdot \frac{{C}_{k}}{{B}_{k}^{l}} ) \qquad ( 1 )$$

$${\sum }_{i ∈ Device} {α}_{i} ( \frac{{A}_{i , k}^{d} \cdot {B}_{k}^{d}}{{C}_{i}^{d}} ) + {\sum }_{j ∈ Link} {b}_{j} ( \frac{{A}_{j , k}^{l} \cdot {B}_{k}^{l}}{{C}_{j}^{l}} ) ≦ {P}_{k} \qquad ( 2 )$$

$${\sum }_{k ∈ App} ( {A}_{i , k}^{d} \cdot {B}_{k}^{d} ) ≦ {C}_{i}^{d} \qquad ( 3 )$$

$${\sum }_{k ∈ App} ( {A}_{j , k}^{l} \cdot {B}_{k}^{l} ) ≦ {C}_{j}^{i} \qquad ( 4 )$$

$$\begin{matrix}{α}_{i} : Device usage cost \\ {b}_{j} : Link usage cost \\ {C}_{i}^{d} : Computation resource upper limit for i - th device \\ {C}_{j}^{i} : Bandwidth upper limit for j - th link \\ {C}_{k} : Data capacity used by k - th application \\ {A}_{i , k}^{d} : Whether i - th device uses k - th application \\ {A}_{i , k}^{l} : Whether j - th link uses k - th application \\ {B}_{k}^{d} : Amount of computation resources used by k - th application \\ {B}_{k}^{l} : Bandwidth used by k - th application \\ {B}_{i , k}^{p} : Processing time of k - th application on i - th device\end{matrix}$$

The objective function is to minimize the response time in Equation (1). One of the constraint conditions is how much does the computation resource of Equation (2) cost. Furthermore, the constraint condition that the server resource upper limit in Equations (3) and (4) is not exceeded is added.

### Parameters of Linear Programming Equation Based on Response Time Requirements

If the response time requirement requires deployment within a few seconds of application response time, the parameters of the linear programming equation shown in [Math. 2]below are used.

$$[ Math . 2 ]$$

$${P}_{k} = {\sum }_{i ∈ Device} {α}_{i} ( \frac{{A}_{i , k}^{d} \cdot {B}_{k}^{d}}{{C}_{i}^{d}} ) + {\sum }_{j ∈ Link} {b}_{j} ( \frac{{A}_{j , k}^{l} \cdot {B}_{k}^{l}}{{C}_{j}^{l}} ) \qquad ( 5 )$$

$${\sum }_{i ∈ Device} ( {A}_{i , k}^{d} \cdot {B}_{i , k}^{p} ) + {\sum }_{j ∈ Link} ( {A}_{j , k}^{l} \cdot \frac{{C}_{k}}{{B}_{k}^{l}} ) ≦ {R}_{k} \qquad ( 6 )$$

$${\sum }_{k ∈ App} ( {A}_{i , k}^{d} \cdot {B}_{k}^{d} ) ≦ {C}_{i}^{d} \qquad ( 3 )$$

$${\sum }_{k ∈ App} ( {A}_{j , k}^{l} \cdot {B}_{k}^{l} ) ≦ {C}_{j}^{i} \qquad ( 4 )$$

$$\begin{matrix}{α}_{i} : Device usage cost \\ {b}_{j} : Link usage cost \\ {C}_{i}^{d} : Computation resource upper limit for i - th device \\ {C}_{j}^{i} : Bandwidth upper limit for j - th link \\ {C}_{k} : Data capacity used by k - th application \\ {A}_{i , k}^{d} : Whether i - th device uses k - th application \\ {A}_{i , k}^{l} : Whether j - th link uses k - th application \\ {B}_{k}^{d} : Amount of computation resources used by k - th application \\ {B}_{k}^{l} : Bandwidth used by k - th application \\ {B}_{i , k}^{p} : Processing time of k - th application on i - th device\end{matrix}$$

The objective function is to minimize the cost of computation resources in Equation (5) corresponding to Equation (2). One of the constraint conditions is how many seconds the response time of Equation (6) corresponding to Equation (1) takes. Furthermore, the constraint conditions of Equations (3) and (4) are also added.

### Explanation of Parameters of Linear Programming Equation

Equations (1) and (6) are the equations for calculating the response time of application k. Rk in Equation (1) is the objective function, and Rk in Equation (6) is a constraint condition that sets an upper limit specified by the user.

Equations (2) and (5) are equations for calculating the cost (price) Pₖ of operating application k. Pₖ in Equation (2) is a constraint condition that sets an upper limit specified by the user, and Pₖ in Equation (5) is the objective function.

Equations (3) and (4) are constraint conditions that set upper limits on computation resources and communication bands, and are calculated including applications deployed by others to prevent the resource upper limit from being exceeded due to application deployment by a new user.

Appropriate application deployment can be calculated by deriving solutions of the linear programming equations (1) to (4) and (3) to (6) using linear programming solvers such as GLPK (Gnu Linear Programming Kit) and CPLEX (IBM Decision Optimization) for different conditions such as the network topology, conversion application type (increase in cost and performance for CPU and the like), user requirements, and existing deployment applications. After calculating the appropriate deployment, actual deployment is performed for multiple users one after another, so that multiple applications are deployed based on the requirements of each user.

As described above, when a new application deployment request is received, calculations are made based on the linear programming equation, and the applications are deployed in order, whereby the applications can be deployed while satisfying the user's requirements.

Here, the deployment of application programs is performed sequentially, so it can be said that it is first come first served. However, the appropriate deployment of the application program group that has already been deployed is recalculated periodically, such as every 100 applications. Then, a deployment that minimizes the objective function may be calculated according to the cost and response time specified by the user, and the application may be redeployed to the calculated position.

### [Evaluation]

Using the free solver GLPK (registered trademark), it was confirmed that multiple applications can be properly deployed based on a linear programming equation, which is one aspect of linear programming, while changing several conditions.

### <Evaluation Conditions>

### Target Application

The application to be deployed performs image processing using Fourier transform, which is expected to be used by many users.

Fourier transform processing (FFT) is used in various monitoring situations in IoT, such as vibration frequency analysis.

NAS.FT (https://www.nas.nasa.gov/publications/npb.html) (registered trademark) is one of the open source applications for FFT processing. The 2048×2048 size of the provided sample test is calculated. In IoT, when considering an application that transfers data from a device to a network, it is assumed that the device side performs primary analysis such as FFT processing and sends the data in order to reduce network costs.

MRI-Q (http://impact.crhc.illinois.edu/parboil/) (registered trademark) calculates a matrix Q representing the scanner configuration for calibration used in 3D MRI reconstruction algorithms in non-Cartesian space. In IoT environments, image processing is often required for automatic monitoring from camera videos, and there is a need for automatic offloading of image processing. MRI-Q is a C language application that performs 3D MRI image processing during performance measurement and measures processing time using large sample data of size 64×64×64. CPU processing is performed using C language, and FPGA processing is performed based on OpenCL (registered trademark).

With the GPU and FPGA automatic offload technology of the present embodiment, NAS.FT can be sped up with GPU, and MRI-Q can be sped up with FPGA, which can be 5 times and 7 times faster than CPU, respectively.

### Evaluation Method

The topology where the application is deployed consists of three layers as shown in FIG. 11, with the number of locations is “5” for the cloud layer, “20” for the carrier edge layer, “60” for the user edge layer, and “300” for the input node. Assuming applications such as IoT, IoT data is collected from input nodes at the user edge, and depending on the characteristics of the application (response time requirements and the like), analytical processing is performed at the user edge and carrier edge, or data is sent to the cloud and then analyzed.

For example, 1,000 applications are deployed based on the user requirements based on the parameters of the linear programming equation shown in [Math. 1] and [Math. 2]. The application is an IoT application that is supposed to analyze data generated from input nodes. Deployment requests are randomly generated from input nodes (assuming there are “300” input nodes).

For example, the number of deployment requests is 1,000 requests for application deployment at a ratio of NAS.FT:MRI-Q=3:1. Further, as a user requirement, price conditions or response time conditions are selected for each application when requesting deployment. In the case of NAS.ET, the selected monthly price upper limit is 7,000 yen, 8,500 yen, or 10,000 yen, and the selected response time upper limit is 6 seconds, 7 seconds, or 10 seconds. In the case of MRI-Q, the selected monthly price upper limit is 12,500 yen or 20,000 yen, and the selected response time upper limit is 4 seconds or 8 seconds.

There are three variation patterns of user requirements. According to pattern 1, ⅙ of 6 types of requests is selected at each time for NAS.FT, and ¼ of 4 types of requests is selected at each time for MRI-Q.

According to pattern 2, the request is that the condition with the lowest price is selected as the upper limit (initially 7,000 yen or 12,500 yen), and if there are no vacancies, the next lowest price condition is selected.

According to pattern 3, the request is that the condition with the minimum response time (initially 6 seconds or 4 seconds) is selected, and if there is no vacancy, the next fastest response time condition is selected.

An example of applying the user requests to NAS.FT and MRI-Q will be described later.

### Simulation of Deployment

The deployment is performed through simulation experiments using solver GLPK5.0 (registered trademark) as an evaluation tool. The simulation uses an evaluation tool to simulate a large-scale network deployment. In actual use, when an application offload request is received, an offload pattern is created through repeated performance tests using a verification environment, and an appropriate amount of resources is determined based on the performance test results in the verification environment (see FIG. 10). Then, the appropriate deployment is determined using GLPK or the like according to the user's request, normality confirmation tests and performance tests when actually deployed are automatically conducted, the results and price are presented to the user, and the use begins after the user's decision.

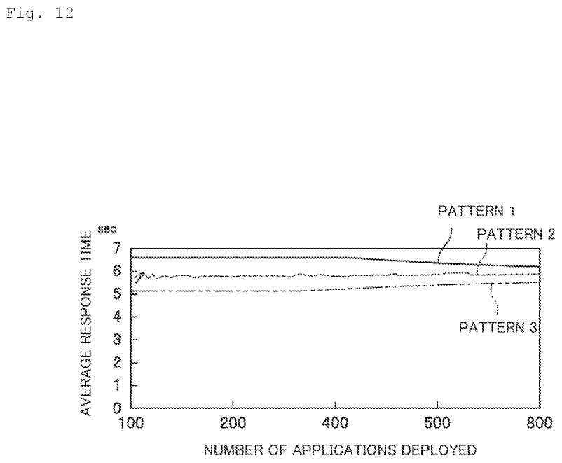

FIG. 12 is a graph showing changes in the number of deployed applications in terms of average response time. FIG. 12 shows the average response time and the number of applications deployed for the three patterns.

It was confirmed that requests are filled in order from the cloud in pattern 2, and are filled in order from the edge in pattern 3. In pattern 1, when a variety of requests come in, they are deployed in a way that satisfies the user's requirements.

As shown in FIG. 12, in pattern 2, all requests are deployed up to 400 locations in the cloud, and the average response time remains the slowest, but it gradually decreases as the cloud fills up.

In pattern 3, NAS.FT is deployed from the user edge and MRI-Q is deployed from the carrier edge. Therefore, the average response time is the shortest. However, as the number increases, the average response time becomes slower because they are also deployed in the cloud. In pattern 2, the average response time is intermediate between patterns 1 and 3, and is arranged according to user requirements. For this reason, in pattern 2, the average response time is appropriately reduced compared to pattern 1, in which everything goes to the cloud at first.

In this way, when software is automatically adapted to the deployment environment and automatically offloaded to GPUs and the like, the cost and response time requirements of users are met. That is, a program is converted so that it can be processed by a device such as a GPU, and after the amount of resources to be allocated is determined, the converted application is optimally deployed.

To summarize, first, the data capacity used by the application, the amount of computation resources, the bandwidth, and the processing time are set based on the data of the performance test conducted in the verification environment when converting the program. Appropriate deployment of applications is calculated based on a linear programming equation from values set for each conversion application and values such as server and link costs set in advance. When deploying an application, based on the price and response time requirements specified by the user, one becomes a constraint condition and the other becomes an objective function. A linear programming solver calculates an appropriate deployment, and the proposed method presents the price and other information to the user when the resource is deployed at the calculated location, and the use begins after the user consents.

For applications that have been automatically offloaded to GPUs and FPGAs, the appropriate deployment is calculated by changing the price conditions, response time conditions, number of deployed applications, and the like requested by the user. In this way, it is possible to deploy applications according to the user's wishes.

As for the deployment of applications after automatic conversion, the optimal deployment in accordance with the requirements of individual users has been described. In the following, a description will be given of the overall optimal deployment taking the deployment status of other users into consideration.

### [Application Deployment Reconfiguration]

### <Necessity of Reconfiguration>

We will discuss the necessity of reconfiguration.

As for the computation node link, a three-layer topology: user edge, carrier edge, and cloud (FIG. 11 and the like) will be assumed. Computation nodes are divided into three types: CPU, GPU, and FPGA. Using virtualization technology, nodes equipped with GPUs and FPGAs are provided as GPU and FPGA instances that also include CPU resources.

For example, the location of servers accommodating virtual networks was systematically designed based on long-term trends such as increases in traffic. In contrast, environment-adaptive software has two characteristics. First, the deployed applications are not statically determined, but are automatically converted for use with GPUs and FPGAs, and patterns suitable for the usage pattern are extracted through actual measurements using genetic algorithms or the like Therefore, application code and performance can change dynamically. Second, it is not only necessary to reduce carrier equipment costs and overall response time, but also to meet individual user requirements regarding response time and price, and application deployment policies can also change dynamically.

Based on these two characteristics, a linear programming method has been described to calculate deployment that satisfies users' response time and price requirements.

Specifically, the linear programming method uses the parameters of the linear programming equations shown in [Math. 1](Equations (1) to (4) below) and [Math. 2](Equations (3) to (6) below). The response time and price of the converted application when a user requests deployment of the application are formulated to minimize either the response time or the price using an objective function.

However, if applications are deployed according to the response time and price requirements of individual users, it is basically first come first served. For example, if there are only requests that prioritize price, the cloud will be filled, and if there are only requests that prioritize speed, the edge will be filled. Once the cloud or edge is full, it is necessary to deploy it on another server. Therefore, in order to alleviate the first-come-first-served deployment, the deployment is reconfigured not only before the start of operation but also after the start of operation.

In the present embodiment, by reconfiguring the deployment after the start of operation, the satisfaction level of a plurality of users targeted for reconfiguration is improved.

### <Formulation of Linear Programming Method>

In the present embodiment, a reconfiguration method for reconfiguring an application to an appropriate deployment location will be described, taking the deployment status of other users into consideration. The formulation of the linear programming method will be also described.

The reconfiguration uses the following method.

For each deployment of a certain number of applications (such as 100 applications), a trial calculation is performed to reconfigure the deployment of a certain number of applications (all applications or 100 applications, or the like) in a manner that satisfies the initial requirements of multiple users. This improves the satisfaction level of the user group, which is determined by changes in response time and prices.

Reconfiguration is performed only when the reconfiguration effect is high, such as when the change in the satisfaction level exceeds a certain threshold as a result of the reconfiguration trial calculation. Actual reconfiguration requires changing the application execution server, so a technique such as live migration is used to reduce the impact on users. Linear programming equations and parameters for reconfiguration are shown in Equations (7), (1), (5), (3), and (4).

$$[ Math . 3 ]$$

$$S = {\sum }_{k ∈ App} ( \frac{{R}_{k}^{after}}{{R}_{k}^{before}} + \frac{{P}_{k}^{after}}{{P}_{k}^{before}} ) \qquad ( 7 )$$

Equation (1) is an expression representing the response time Rₖ of the deployed application. The response time before reconfiguration is called Rₖ^{before}, and the response time after reconfiguration is called Rₖ^{after}.

Equation (5) is an expression representing the price Pk of the deployed application. The price before reconfiguration is called Pₖ^{before}, and the price after reconfiguration is called Pₖ^{after}.

Equations (1) and (5) serve as constraint conditions or objective functions depending on the response time and price requirements of the user who requests application deployment (see below). Furthermore, whether the server resource upper limit in Equations (3) and (4) is not exceeded is added as a constraint condition.

First, the new deployment is performed according to Equations (1), (5), (3), and (4).

Users can set requirements for response time, price, or both during deployment. That is, the response time requirement Rₖupper (here, upper refers to superscripts), the price requirement Pₖupper, or both. When Rₖupper is specified, Rₖ≤Rₖupper in Equation (1) becomes a constraint condition, and Equation (5) becomes an objective function. When Pₖupper is specified, Pₖ≤Pₖupper in Equation (5) becomes a constraint condition, and Equation (1) becomes an objective function. When both Rₖupper and Pₖupper are specified, both Rₖ≤Rₖupper in Equation (1) and Pₖ≤Pₖ upper in Equation (5) become constraint conditions, and the user specifies which of Rₖ in Equation (1) and Pₖ in Equation (5) should be minimized as the objective function. Equations (3) and (4) are constraint conditions in both cases.

Equations (3) and (4) are constraint conditions that set upper limits on computation resources and communication bands, and are calculated including applications deployed by other users to prevent the resource upper limit from being exceeded due to application deployment by a new user. New deployment is performed by sequentially calculating Equations (1), (5), (3), and (4) in response to a user's deployment request.

### <Reconfiguration>

Next, a description will be given of reconfiguration for overall optimal deployment taking the deployment status of other users into consideration.

The reconfiguration is calculated according to Equations (7), (1), (5), (3), and (4), but in particular, calculation of the value S corresponding to the user satisfaction level of Equation (7) is newly added.

As an individual user's satisfaction level, if the response time before reconfiguration is 1 point and the price is 1 point as the basic values, and the response time before reconfiguration Rₖ^{before} is X times the response time after reconfiguration Rₖ^{after}, then X is the value related to response time satisfaction level. Furthermore, if the price before reconfiguration Pₖ^{before} is Y times the price after reconfiguration Pₖ^{after}, then Y is the value related to price satisfaction level.

The objective function of the reconfiguration trial calculation is a value related to the user group satisfaction level of a certain number of reconfiguration target applications, and calculates the deployment that minimizes the sum of (X+Y) for multiple applications. The specific content of the objective function is the value S that corresponds to the user satisfaction level in Equation (7).

Furthermore, if the user specifies only one constraint condition when deploying a new application, only one of Equations (1) and (5) is specified in the application.

Based on the linear programming equations (7), (1), (5), (3), and (4), GLPK (registered trademark), CPLEX (IBM Decision Optimization) (registered trademark), and the like are used to calculate the effect of the reconfiguration by deriving a solution with a linear programming solver.

The number of reconfiguration target applications is a constant value, and may not include all applications. Solver calculation time increases as the number of applications for which reconfiguration is calculated increases. Therefore, the setting for a fixed number of applications is variable, and whether 100 applications will be optimized for every 100 deployments, all applications will be optimized at once, or the like is determined by adjusting the size according to the calculation time of the solver.

### [Evaluation]

### <Evaluation Conditions>

### Target Application

The deployment applications are Fourier transform and image processing, which are expected to be used by many users. Fourier transform processing FFT (Fast Fourier Transform) is used in various monitoring situations in IoT, such as vibration frequency analysis. NAS.FT (registered trademark) is one of the open source applications for FFT processing. The 2048×2048 size of the provided sample test is calculated. MRI-Q (registered trademark) calculates a matrix Q representing the scanner configuration for calibration used in 3D MRI reconstruction algorithms in non-Cartesian space. MRI-Q performs 3D MRI image processing during performance measurement and measures processing time using large sample data of size 64×64×64.

With this GPU and FPGA automatic offload technology, NAS.FT can be sped up with GPU, and MRI-Q can be sped up with FPGA, which can be 5 times and 7 times faster than CPU, respectively.

### [Evaluation]

### <Evaluation Method>

The evaluation method will be explained.

The topology where the application is deployed consists of three layers as shown in FIG. 11, with the number of locations is 5 for the cloud layer, 20 for the carrier edge layer, 60 for the user edge layer, and 300 for the input node.

In each location, the server on the cloud will have 8 CPUs, 4 GPUs with 16 GB RAM, and 2 FPGAs. In addition, the carrier edge will have 4 CPUs, 2 GPUs with 8 GB RAM, and 1 FPGA. In addition, the user edge will have 2 CPUs and 1 GPU with 4 GB RAM.

The monthly cost for using all resources of one server (GPU with 16 GB RAM is used) is 50,000 yen, 100,000 yen, and 120,000 yen in the cloud. Due to the aggregation effect, carrier edges and user edges are more expensive, with monthly charges 1.25 times and 1.5 times that of the cloud. Regarding the link, a bandwidth of 100 Mbps is secured between the cloud and the carrier edge, and a bandwidth of 10 Mbps is secured between the carrier edge and the user edge. Regarding link costs, a 100 Mbps link costs 8,000 yen per month, and a 10 Mbps link costs 3,000 yen per month.

For the resources used by the application, such as processing time, the values when actually offloaded to the GPU or FPGA are used. NAS.FT uses resources of GPU with 1 GB RAM, the used bandwidth is 2 Mbps, the amount of transferred data is 0.2 MB, and the processing time is 5.8 seconds. MRI-Q uses 10% of the FPGA server resources (the number of flip flops, look up tables, and the like used is the FPGA resources used), the used bandwidth is 1 Mbps, the amount of transferred data is 0.15 MB, and the processing time is 2.0 seconds.

First, 900 new applications are deployed.

The application randomly generates deployment requests from 300 input nodes, with the assumption that data generated from the input nodes will be analyzed. As the number of deployment requests, the application deployment request is made 900 times at a ratio of NAS.FT:MRI-Q=3:1.

As user requirements, price conditions, response time conditions, or both are selected when requesting deployment. In the case of NAS.FT, the selected monthly price upper limit is 7,500 yen (a), 8,500 yen (b), or 10,000 yen (c), and the selected response time upper limit is 6 seconds (A), 7 seconds (B), or 10 seconds (C). In the case of MRI-Q, the selected monthly price upper limit is 12,500 yen (x) or 20,000 yen (y), and the selected response time upper limit is 4 seconds (X) or 8 seconds (Y).

In NAS.FT, for example, it is assumed that there are 12 types of user requests: request a, request b, request c, request A, request B, request C, request aC, request bB, request bC, request cA, request cB, request cC. Further, in MRI-Q, for example, it is assumed that there are seven types of user requests: request x, request y, request X, request Y, request xY, request yX, and request yY.

As a user request, NAS.FT selects user requests a, b, c, A, B, C, aC, bB, bC, cA, cB, cC with a probability of 1/12, and MRI-Q selects user requests x, y, X, Y, xY, yX, and yY with a probability of 1/7. When the user's upper limit requirement includes one index, the objective function is to minimize another index, and when user's upper limit requirement includes two indices, one is randomly selected and the objective function is to minimize it.

After 900 applications are deployed, a certain number of applications are reconfigured every 100 applications deployed.

The number of deployed applications in the deployment cycle is fixed at 100, but the number of reconfiguration target applications is varied to 100, 200, and 400 applications, and user satisfaction level is calculated.

### <Flowchart>

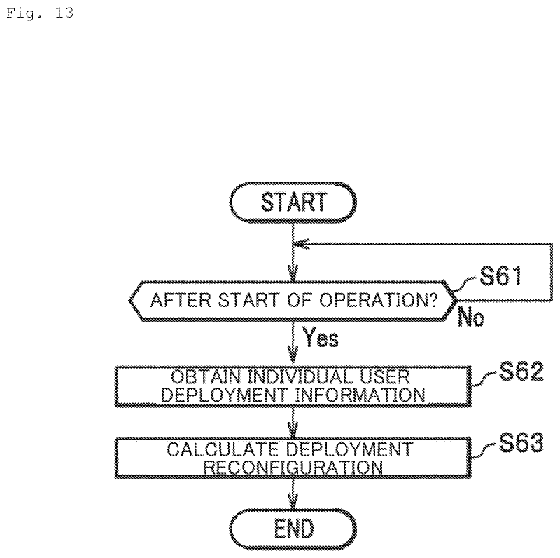

FIG. 13 is a flowchart of reconfiguration for overall optimal deployment taking the deployment status of other users into consideration.

In step S61, the deployment reconfiguration unit 180 determines whether to perform reconfiguration after the start of operation.

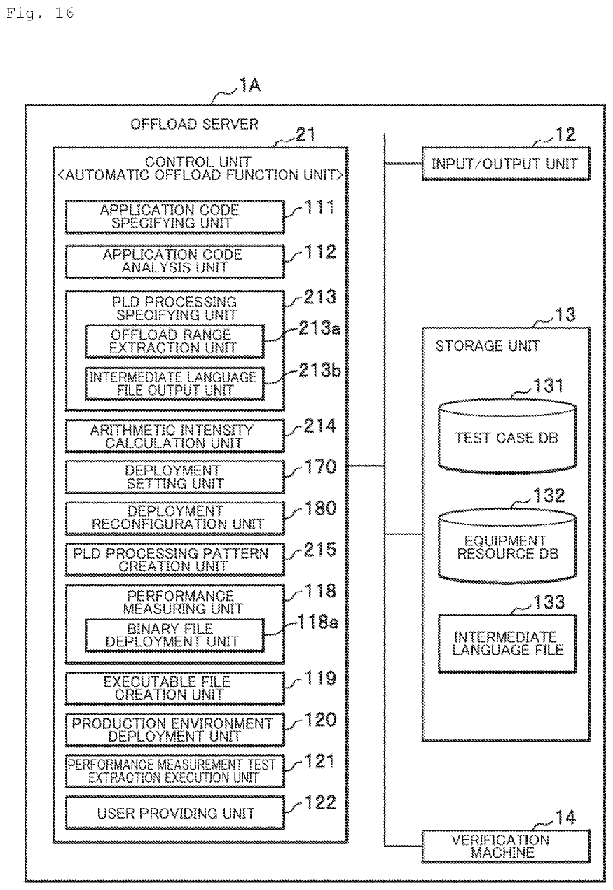

How to determine reconfiguration after the start of operation will be described. The cloud/edge service provider may determine whether to perform deployment reconfiguration calculations, for example, every 100 application deployments, and then the deployment reconfiguration unit 180 (FIG. 16) may be activated every predetermined number of deployments to perform deployment reconfiguration calculations. If the result of the deployment reconfiguration calculation is that, when the average value of S is not less than 2, no improvement is made and no redeployment is performed. Further, a threshold value may be determined such that redeployment is performed only when the average value of S is 2 or less.

When reconfiguring after the start of operation, the deployment reconfiguration unit 180 acquires individual user deployment information in step S62.

In step S63, the deployment reconfiguration unit 180 calculates the effect of reconfiguration by deriving a solution using a linear programming solver such as GLPK (registered trademark) and CPLEX (IBM Decision Optimization (registered trademark) based on the linear programming equations (7), (1), (5), (3), and (4) and the processing of this flow ends.

### <Result>

The experiment was conducted by simulation using solver GLPK5.0 (registered trademark).

Regarding calculation time, new deployment only requires calculating and deploying a total of 500 applications in order, so it can be completed in less than 1 minute. On the other hand, in terms of reconfiguration time, as the number of reconfiguration target applications increases, the number of linear programming conditional expressions increases. However, for 100 applications it took less than 10 seconds, and for 400 applications it took less than 1 minute.

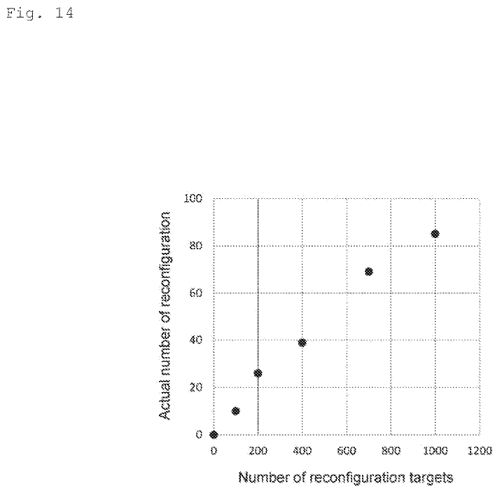

FIG. 14 is a graph showing changes in the number of actually configured applications. The number of reconfiguration target applications is plotted on the horizontal axis, and the number of applications actually reconfigured is plotted on the vertical axis.

As shown in FIG. 14, it can be seen that approximately 10% of the number of reconfiguration target applications are actually reconfigured, although there is some variation. In new deployment, each application is individually optimally deployed. However, in reconfiguration, the appropriate deployment of multiple applications is calculated at once, it can be seen that some reconfigurable applications can be found.

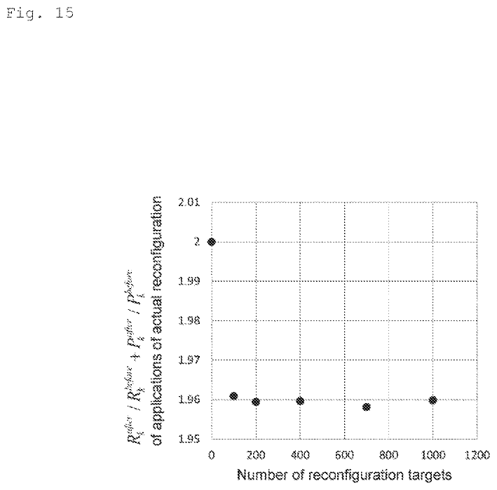

FIG. 15 is a graph showing changes in Rₖ^{after}/Rₖ^{before}+Pₖ^{after}/Pₖ^{before} of an actually reconfigured application. The number of actually reconfigured applications is plotted on the horizontal axis, and the average value of Rₖ^{after}/Rₖ^{before}+Pₖ^{after}/Pₖ^{before} of the actually reconfigured applications is plotted on the vertical axis.

As shown in FIG. 15, it can be seen that the average Rₖ^{after}/Rₖ^{before}+Pₖ^{after}/Pₖ^{before} of the reconfigured applications has been improved to about 1.96. This value is not a big improvement from 2, but for example, when the deployment of NAS.ET is changed from the carrier edge to the cloud, the response time will change from 6.6 seconds to 7.4 seconds, but the price will change from about 8,400 yen to about 7000 yen, the value will be changed from 2 to 1.954. As shown in FIG. 15, it can be seen that this value is almost constant regardless of the number of reconfiguration target applications, and it is not necessary to target all applications for reconfiguration.

### <Discussion>

A method that enables reconfiguration to the overall optimal deployment by taking the deployment status of other users into consideration has been described. As shown in FIGS. 14 and 15, the effectiveness of the reconfiguration during operation was confirmed. In addition to deployment, reconfiguration during operation can also include changes in offload logic to GPUs and FPGAs, changes in resource balance, and the like, and the scope of environmental adaptation that corresponds to changes in operation can be expanded.

With the above-mentioned overall optimization deployment method that takes the deployment status of other users into consideration, by reconfiguring even individually optimized applications when new deployment is done, approximately 10% of applications have Rₖ^{after}/Rₖ^{before}+Pₖ^{after}/Pₖ^{before} of 2 or less. In this way, it is possible to improve indices that are directly linked to the satisfaction level, such as response time and price, even after the start of operation. This value is almost constant regardless of the number of reconfiguration target applications, and the calculation time does not increase much even if the number of reconfiguration target applications increases. Thus, it is considered that the number of reconfiguration calculations and the like should be set depending on the business timing of obtaining a reconfiguration proposal and permission from the user of the application to be reconfigured. When deploying a new application, compared to naively deploying it to the cloud or edge, the deployment can be tailored to the user's requirements, making it possible to operate with a high user satisfaction level through new deployment and reconfiguration after startup.

### SUMMARY

In this way, as a new element of environment-adaptive software, a reconfiguration method that improves the target user's satisfaction level by redeploying the application while taking the application deployment status of other users after the start of operation into consideration can be realized.

In summary, this reconfiguration method uses a linear programming method to perform trial calculations using the objective function of improving the user group satisfaction level for the reconfiguration target application. Specifically, after the user response time and price requirements are satisfied, the user satisfaction level determined from the response time and price when reconfigured is calculated, and then a linear programming solver is used to solve the multiple reconfiguration target applications.

Simulation experiments assuming multiple types of applications were conducted, the improvement in user satisfaction level when reconfiguring using this reconfiguration method was confirmed, and its effectiveness was confirmed.

### Second Embodiment

Next, an offload server 1A and the like in the second embodiment of the present invention will be explained. The second embodiment is an example of application to FPGA automatic offloading of loop statements.

In the present embodiment, an example in which the present invention is applied to an FPGA (Field Programmable Gate Array) as a PLD (Programmable Logic Device) will be described. The present invention is applicable to programmable logic devices in general.

### (Explanation of Principle)

Since it is difficult to predict which loops should be offloaded to increase speed on FPGAs, automatic measurement in a verification environment similar to GPUs has been proposed. However, with FPGAs, it takes several hours or more to compile OpenCL and run it on an actual device, so iterative measurements using GA with GPU automatic offloading would not be possible because it takes an enormous amount of processing time. Therefore, the candidate loop statements to be offloaded to the FPGA are narrowed down and then measurements are performed. Specifically, loop statements with high arithmetic intensity are extracted from the discovered loop statements using an arithmetic intensity analysis tool such as ROSE (registered trademark). Furthermore, loop statements with a large loop count are also extracted using a profiling tool such as gcov (registered trademark).

Loop statements with high arithmetic intensity and loop count are selected as candidates and converted to OpenCL. When converting to OpenCL, the CPU processing program is divided into the kernel (FPGA) and host (CPU) according to the OpenCL syntax. The created OpenCL is precompiled for candidate loop statements to find loop statements with high resource efficiency. Since the resources to be created can be known during compiling, the loop statement can be further narrowed down to loop statements that use a sufficiently small amount of resources.

Since some candidate loop statements remain, performance and power usage are actually measured using them. The selected single-loop statements are compiled and measured, and for the single-loop statements that can be further sped up, combination patterns thereof are created and a second measurement is performed. Among the measured patterns, a pattern with a short time and low power consumption is selected as a solution.

Regarding FPGA offloading of loop statements, after narrowing down using arithmetic intensity or the like, measurement is performed and the evaluation value of low-power patterns is increased to automatically speed up and reduce power consumption.

FIG. 16 is a functional block diagram showing a configuration example of the offload server 1A according to the second embodiment of the present invention. In the description of the present embodiment, the same components as those in FIG. 1 are given the same reference numerals, and the explanation of the overlapping parts will be omitted.

The offload server 1A is a device that automatically offloads specific processing of an application to an accelerator. Further, the offload server 1A can be connected to an emulator.

As shown in FIG. 16, the offload server 1A includes a control unit 21, an input/output unit 12, a storage unit 13, and a verification machine 14 (accelerator verification device).

The control unit 21 is an automatic offloading function unit that controls the entire offload server 1A. The control unit 21 is realized, for example, by a CPU (not shown) expanding a program (offload program) stored in the storage unit 13 into a RAM and executing the program.

The control unit 21 includes an application code specifying unit (specify application code) 111, an application code analysis unit (analyze application code) 112, a PLD processing specifying unit 213, an arithmetic intensity calculation unit 214, a deployment setting unit 170, a reconfiguration unit 180, a PLD processing pattern creation unit 215, a performance measuring unit 118, an executable file creation unit 119, a production environment deployment unit (deploy final binary files to production environment) 120, a performance measurement test extraction execution unit (extract performance test cases and run automatically) 121, and a user providing unit (provide price and performance to a user to judge) 122.

### <PLD Processing Specifying Unit 213>

The PLD processing specifying unit 213 identifies loop statements (repetition statements) in the application, and creates and compiles multiple offload processing patterns for each identified loop statement, specifying pipeline processing and parallel processing in the PLD using OpenCL.

The PLD processing specifying unit 213 includes an offload range extraction unit (extract offloadable area) 213a and an intermediate language file output unit (output intermediate file) 213b.

The offload range extraction unit 213a identifies processing that can be offloaded to the FPGA, such as loop statements and FFTs, and extracts an intermediate language according to the offload processing.

The intermediate language file output unit 213b outputs the extracted intermediate language file 133. The intermediate language extraction is not terminated at once, and repeated for attempting and optimizing execution for appropriate offload area search.

### <Arithmetic Intensity Calculation Unit 214>

The arithmetic intensity calculation unit 214 uses an arithmetic intensity analysis tool such as the ROSE framework (registered trademark) to calculate the arithmetic intensity of the loop statement of the application. Arithmetic intensity is a value (FN operations/memory access) obtained by dividing the number of floating point operations (floating point number, FN) executed during program execution by the number of bytes accessed to main memory.

Arithmetic intensity is an index that increases when the number of calculations is large and decreases when the number of accesses is large, and processing with high arithmetic intensity becomes heavy processing for the processor.

Therefore, the arithmetic intensity of the loop statement is analyzed using an arithmetic intensity analysis tool. The PLD processing pattern creation unit 215 narrows down loop statements with high arithmetic intensity to offload candidates.

An example of calculating arithmetic intensity will be described.

It is assumed that floating point calculation processing is performed 10 times (10 FLOPs) in one loop, and the data used in the loop is 2 bytes. When the same size of data is used in each loop, the arithmetic intensity is 10/2=5 [FLOP/byte]. Note that the loop count is not considered in the arithmetic intensity, so in the present embodiment, the loop count is also considered in addition to the arithmetic intensity to narrow down the results.

### <PLD Processing Pattern Creation Unit 215>

The PLD processing pattern creation unit 215 narrows down loop statements whose arithmetic intensity is higher than a predetermined threshold (hereinafter referred to as high arithmetic intensity as appropriate) as offload candidates based on the arithmetic intensity calculated by the arithmetic intensity calculation unit 214 and creates a PLD processing pattern.

In addition, as a basic operation, the PLD processing pattern creation unit 215 excludes loop statements (repetition statements) that cause compile errors from being offloaded, and creates a PLD processing pattern that specifies whether to perform PLD processing for repetition statements that do not cause compile errors.

### Loop Count Measurement Function

As a loop count measurement function, the PLD processing pattern creation unit 215 uses a profiling tool to measure the loop count of the loop statements of the application, and narrow down the loop statements to those with high arithmetic intensity and a loop count greater than a predetermined number (hereinafter referred to as high loop count as appropriate). To understand the loop count, use GNU Coverage's gcov, and the like “GNU Profiler (gprof)” and “GNU Coverage (gcov)” are known as profiling tools. Either can be used since both can check the number of executions of each loop.

Furthermore, in arithmetic intensity analysis, the loop count is not particularly visible, so in order to detect loops that have a large loop count and a high load, a profiling tool is used to measure the loop count. Here, the height of arithmetic intensity represents whether processing is suitable for offloading to the FPGA, and (loop count)x(arithmetic intensity) represents whether the load related to offloading to the FPGA is high.

### OpenCL (Intermediate Language) Creation Function

As an OpenCL creation function, the PLD processing pattern creation unit 215 creates OpenCL (converts into OpenCL) for offloading each narrowed-down loop statement to the FPGA. That is, the PLD processing pattern creation unit 215 compiles OpenCL that offloads the narrowed-down loop statements. In addition, the PLD processing pattern creation unit 215 creates a list of loop statements whose performance has been improved compared to the CPU among those whose performance has been measured, and creates OpenCL for offloading by combining the loop statements in the list.

Conversion to OpenCL will be described.

The PLD processing pattern creation unit 215 converts the loop statement into a high-level language such as OpenCL. First, a CPU processing program is divided into a kernel (FPGA) and a host (CPU) according to the grammar of a high-level language such as OpenCL. For example, if it is desired to process one out of ten for statements on an FPGA, that one is cut out as a kernel program and written according to OpenCL syntax. An example of OpenCL syntax will be described later.

Furthermore, it is also possible to incorporate techniques to speed up the division. In general, in order to increase the speed by using the FPGA, a local memory cache, a stream processing, a plurality of instances, a processing for developing loop statements, an integration of nested loop statements, a memory interleaving, and the like are used. Although there is no absolute effect depending on the loop statement, these are often used as a method for increasing the speed of the loop statement.

A kernel created according to OpenCL C language syntax is executed on a device (for example, FPGA) by a program on the host (for example, CPU) side created using OpenCL C language runtime API. The part to call the kernel function hello( ) from the host side is to call clEnqueueTask( ), which is one of the OpenCL runtime APIs.

The basic flow of OpenCL initialization, execution, and termination written in host code consists of steps 1 to 13 below. Among these steps 1 to 13, steps 1 to 10 are the procedure (preparation) until the kernel function hello( ) is called from the host side, and step 11 is the execution of the kernel.

### 1. Identify Platform

The platform on which OpenCL runs is identified using the function clGetPlatformIDs( ), which provides a platform identification function defined in the OpenCL runtime API.

### 2. Identify Device

Devices such as GPUs used on the platform are identified using the function clGetDeviceIDs( ), which provides a device identification function defined in the OpenCL runtime API.

### 3. Create Context

An OpenCL context, which is the execution environment for running OpenCL, is created using the function clCreateContext( ), which provides a context creation function defined in the OpenCL runtime API.

### 4. Create Command Queue

A command queue that is ready to control the device is created using the function clCreateCommandQueue( ), which provides a command queue creation function defined in the OpenCL runtime API. In OpenCL, operations from the host to the device (issuance of kernel execution commands and memory copy commands between host and device) are executed through the command queue.

### 5. Create Memory Object

A memory object that allows the host to reference the memory object is created using the function clCreateBuffer( ), which provides a function to allocate memory on the device defined by the OpenCL runtime API.

### 6. Read Kernel File

The execution of the kernel executed on the device is controlled by the host-side program. Therefore, the host program must first read the kernel program. A kernel program includes binary data created with an OpenCL compiler and source code written in the OpenCL C language. This kernel file is read (description omitted). Note that the OpenCL runtime API is not used when reading the kernel file.

### 7. Create Program Object

OpenCL recognizes kernel programs as program objects. This procedure is program object creation.

A program object that allows the host to reference the memory object is created using the function clCreateProgramWithSource( ), which provides a program object creation function defined in the OpenCL runtime API. When creating a kernel program from a compiled binary string, clCreateProgramWithBinary( ) is used.

### 8. Build

The program object registered as source code is built using the OpenCL C compiler/linker.

A program object is built using the function clBuildProgram( ), which executes a build using the OpenCL C compiler/linker defined in the OpenCL runtime API. Note that this compiling procedure is not necessary if a program object is generated from a compiled binary string using clCreateProgramWithBinary( ).

### 9. Create Kernel Object

A kernel object is created using the function clCreateKernel( ), which provides a kernel object creation functional defined in the OpenCL runtime API. One kernel object corresponds to one kernel function, so the name of the kernel function (hello) is specified when creating a kernel object. Furthermore, when multiple kernel functions are written as one program object, one kernel object corresponds to one kernel function on a one-to-one basis, so clCreateKernel( ) is called multiple times.

### 10. Kernel Argument Settings

Kernel arguments are set using the function clSetKernel( ), which provides the function of giving arguments to the kernel (passing values to arguments held by kernel functions) defined in the OpenCL runtime API.

Now that steps 1 to 10 complete the preparation, the processing proceeds to step 11 of executing the kernel on the device from the host side.

### 11. Kernel Execution

Kernel execution (submitting to the command queue) acts on the device, so it becomes a queuing function to the command queue. The command to execute kernel hello on the device is queued using the function clEnqueueTask( ), which provides a kernel execution function defined in the OpenCL runtime API. After the command to execute the kernel hello is queued, it will be executed on an executable computation unit on the device.

12. Read from Memory Object

Data is copied from the device-side memory area to the host-side memory area using the function clEnqueueReadBuffer( ), which provides the function to copy data from the device-side memory to the host-side memory defined in the OpenCL runtime API. Additionally, Data is copied from the host-side memory area to the device-side memory area using the function clEnqueueWrightBuffer( ), which provides a function to copy data from the host side to the client-side memory. Note that these functions operate on the device, so data copying begins once a copy command is queued in the command queue.

### 13. Object Release

Finally, various objects created so far are released. The above describes device execution of a kernel created according to the OpenCL C language.

### Resource Amount Calculation Function

As a resource amount calculation function, the PLD processing pattern creation unit 215 precompiles the created OpenCL and calculates the amount of resources to be used (“first resource amount calculation”). The PLD processing pattern creation unit 215 calculates resource efficiency based on the calculated arithmetic intensity and resource amount, and selects c loop statements whose resource efficiency is higher than a predetermined value in each loop statement based on the calculated resource efficiency.

The PLD processing pattern creation unit 215 precompiles the loop statement using the combined offload OpenCL and calculates the amount of resources to be used (“second resource amount calculation”). Here, instead of precompiling, it is also possible to use the sum of the resource amounts in precompiling before the first measurement.

### <Performance Measuring Unit 118>

The performance measuring unit 118 compiles the application of the created PLD processing pattern, deploys it on the verification machine 14, and executes processing of measuring performance when offloaded to the PLD.

The performance measuring unit 118 executes the deployed binary file, measures the performance when offloaded, and returns the performance measurement result to the offload range extraction unit 213a. In this case, the offload range extraction unit 213a extracts another PLD processing pattern, and the intermediate language file output unit 213b attempts performance measurement based on the extracted intermediate language (see symbol a in FIG. 2)).

The performance measuring unit 118 includes a binary file deployment unit (deploy binary files) 118a. The binary file deployment unit 118a deploys an executable file derived from the intermediate language on the verification machine 14 equipped with a GPU.

A specific example of performance measurement will be described.

The PLD processing pattern creation unit 215 narrows down loop statements with high resource efficiency and compiles OpenCL that offloads the loop statements narrowed down by the executable file creation unit 119. The performance measuring unit 118 measures the performance of the compiled program (“first performance measurement”).

Then, the PLD processing pattern creation unit 215 creates a list of loop statements whose performance has been improved compared to the CPU among those whose performance has been measured. The PLD processing pattern creation unit 215 combines the loop statements in the list to create OpenCL for offloading. The PLD processing pattern creation unit 215 precompiles the loop statement using the combined offload OpenCL and calculates the amount of resources to be used. Note that, instead of precompiling, it is also possible to use the sum of the resource amounts in precompiling before the first measurement. The executable file creation unit 119 compiles the combined offload OpenCL, and the performance measuring unit 118 measures the performance of the compiled program (“second performance measurement”).

### <Executable File Creation Unit 119>

The executable file creation unit 119 selects the PLD processing pattern with the highest evaluation value from the plurality of PLD processing patterns based on the measurement results of the processing time repeated a predetermined number of times, and compiles the PLD processing pattern with the highest evaluation value to create an executable file.

The automatic offload operation of the offload server 1A configured as described above will be described below.

### [Automatic Offload Operation]

The offload server 1A of the present embodiment is an example in which automatic offloading of user application logic to an FPGA is applied as an elemental technology of environment-adaptive software.

An explanation will be given with reference to automatic offload processing of the offload server 1A shown in FIG. 2. As shown in FIG. 2, the offload server 1A is applied to elemental technology of environment-adaptive software. The offload server 1A includes a control unit (automatic offload function unit) 11, a test case DB 131, an intermediate language file 133, and a verification machine 14.

The offload server 1A obtains an application code 125 used by the user.

A user uses, for example, various devices 151, a device 152 with CPU-GPU, a device 153 with CPU-FPGA, and a device 154 with CPU. The offload server 1A automatically offloads functional processing to the accelerator of the device 152 with CPU-GPU and the device 153 with CPU-FPGA.

Hereinafter, an operation of each unit will be described with reference to the step number of FIG. 2.

### <Step S21: Specify Application Code>

In step S21, the application code specifying unit 111 (see FIG. 16) specifies the processing function (image analysis and the like) of the service provided to the user. Specifically, the application code specifying unit 111 specifies the input application code 125.

### <Step S12: Analyze Application Code>

In step S12, the application code analysis unit 112 (see FIG. 16) analyzes the source code of the processing function and understands the structure of specific library usage such as loop statements and FFT library calls.

### <Step S13: Extract Offloadable Area>

In step S13, the PLD processing specifying unit 213 (see FIG. 16) identifies loop statements (repetition statements) of the application, specifies parallel processing or pipeline processing in the FPGA for each repetition statement, and performs compiling using a high-level synthesis tool. Specifically, the offload range extraction unit 213a (see FIG. 16) specifies processing that can be offloaded to the FPGA, such as a loop statement, and extracts OpenCL as an intermediate language corresponding to the offload processing.

### <Step S14: Output Intermediate File>

In step 514, the intermediate language file output unit 213b (see FIG. 16) outputs the intermediate language file 133. The intermediate language extraction is not terminated at once, and repeated for attempting and optimizing execution for appropriate offload area search.

### <Step 515: Compile Error>

In step S15, the PLD processing pattern creation unit 215 (see FIG. 16) excludes loop statements that cause compile errors from being offloaded and creates a PLD processing pattern that specifies whether to perform FPGA processing on repetition statements that do not cause compile errors.

### <Step S21: Deploy Binary Files>

In step S21, the binary file deployment unit 118a (see FIG. 16) deploys the executable file derived from the intermediate language to the verification machine 14 equipped with an FPGA. The binary file deployment unit 118a starts the deployed file, executes an assumed test case, and measures the performance when offloaded.

### <Step S22: Measure Performances>

In step S22, the performance measuring unit 118 (see FIG. 16) executes the deployed file and measures the performance and power usage when offloaded.

In order to make the area to be offloaded more appropriate, this performance measurement result is returned to the offload range extraction unit 213a, and the offload range extraction unit 213a extracts another pattern. Then, the intermediate language file output unit 213b attempts performance measurement based on the extracted intermediate language (see symbol a in FIG. 2). The performance measuring unit 118 repeatedly measures performance and power consumption in the verification environment, and finally determines the code pattern to be deployed.

As indicated by symbol a in FIG. 2, the control unit 21 repeatedly executes steps S12 to S22. The automatic offload function of the control unit 21 is summarized below. That is, the PLD processing specifying unit 213 identifies loop statements (repetition statements) in the application, specifies parallel processing or pipeline processing in the FPGA for each repetition statement in OpenCL (intermediate language), and performs compiling using a high-level synthesis tool. Then, the PLD processing pattern creation unit 215 excludes loop statements that cause compile errors from being offloaded, and creates a PLD processing pattern that specifies whether to perform PLD processing for loop statements that do not cause compile errors. Then, the binary file deployment unit 118a compiles the application of the corresponding PLD processing pattern and deploys it on the verification machine 14, and the performance measuring unit 118 executes the performance measurement processing on the verification machine 14. The executable file creation unit 119 selects a pattern with the highest evaluation value (for example, a pattern with the highest evaluation value=(processing time)−½) from multiple PLD processing patterns based on the performance measurement results repeated a predetermined number of times and compiles the selected pattern to create an executable file.

### <Step S23: Deploy Final Binary Files to Production Environment>

In step S23, the production environment deployment unit 120 determines the pattern specifying a final offload area and deploys it to a production environment for users.

### <Step S24: Extract Performance Test Cases and Run Automatically>

In step S24, after deploying the executable file, the performance measurement test extraction execution unit 121 extracts performance test items from the test case DB 131 and automatically executes the extracted performance tests in order to show the performance to the user.

### <Step S25: Provide Price and Performance to a User to Judge>

In step S25, the user providing unit 122 presents information such as price and performance based on the performance test result to the user. The user determines the start of charging use of the service on the basis of the presented information such as the price and the performance.

The steps S21 to S25 are performed in the background of the service use of the user, and for example, it is assumed that steps S21 to S25 are performed during the first day of temporary use. Furthermore, the processing performed in the background to reduce costs may be limited to GPU/FPGA offloading.

As mentioned above, when the control unit (automatic offload function unit) 21 of the offload server 1A is applied to the elemental technology of environment-adaptive software, the control unit (automatic offload function unit) 21 extracts the area to be offloaded from the source code of the application used by the user in order to offload function processing and outputs an intermediate language (steps S12 to 315). The control unit 21 deploys and executes the executable file derived from the intermediate language on the verification machine 14, and verifies the offload effect (steps S21 to S22). After repeating the verification and determining an appropriate offload area, the control unit 21 deploys the executable file to the production environment actually provided to the user and provides it as a service (step S26).

Note that although the processing flow in which code conversion, resource amount adjustment, and deployment location adjustment necessary for environment adaptation are performed in batches has been described above, the processing flow is not limited to this, and it is also possible to extract only the processing that is desired to be performed. For example, if it is only desired to perform code conversion for FPGA, it is only necessary to use the necessary parts such as the environment-adaptive function and the verification environment in steps S21 to S25.

### [FPGA Automatic Offload]

In the code analysis described above, application codes are analyzed using a syntax analysis tool such as Clang. Code analysis is difficult to generalize because it requires analysis assuming the device to be offloaded. However, it is possible to understand the structure of the code such as loop statements and variable reference relationships, or to know that the functional block is a functional block that performs FFT processing, or that it calls a library that performs FFT processing. It is difficult for an offload server to automatically determine the functional block. This can also be determined by determining the degree of similarity using a similar code detection tool such as Deckard. Here, Clang is a tool for C/C++, but it is necessary to choose a tool that matches the language to be analyzed.

Additionally, when offloading application processing, consideration must be given to each offload destination, such as GPU, FPGA, and IoT GW. In general, when it comes to performance, it is difficult to automatically discover the settings that give maximum performance at once. For this reason, offload patterns are tested by repeating performance measurements several times in a verification environment to find patterns that can increase speed.

A method for offloading loop statements of application software to FPGAs will be described below.

### [Flowchart]

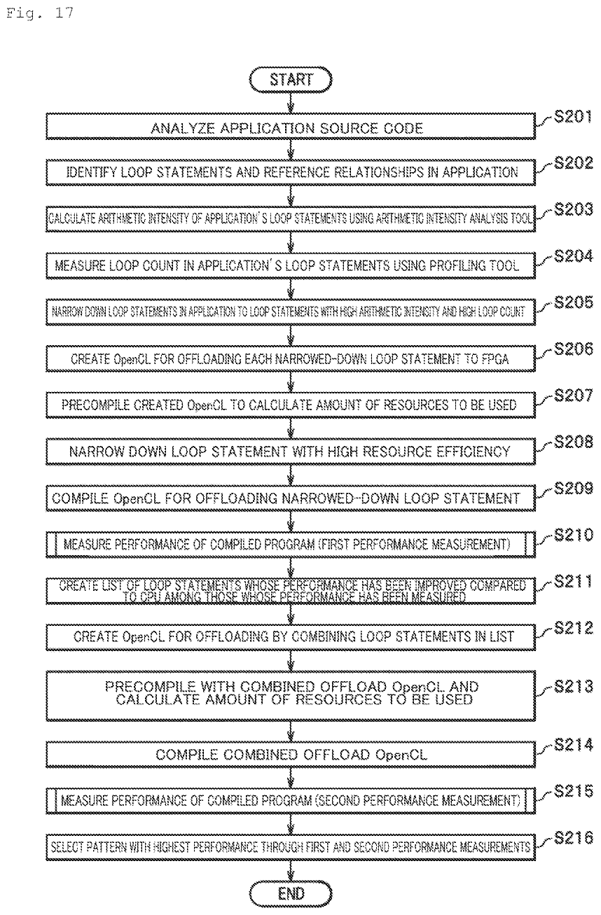

FIG. 17 is a flowchart showing an overview of the operation of the offload server 1A.

In step S201, the application code analysis unit 112 analyzes the source code of the application to be offloaded. The application code analysis unit 112 analyzes information on loop statements and variables according to the language of the source code.

In step S202, the PLD processing specifying unit 213 identifies loop statements and reference relationships of the application.

Next, the PLD processing pattern creation unit 215 performs processing to narrow down candidates as to whether to attempt FPGA offloading for the identified loop statement. An arithmetic intensity is one index for whether the loop statement has the offload effect.

In step S203, the arithmetic intensity calculation unit 214 calculates the arithmetic intensity of the loop statement of the application using an arithmetic intensity analysis tool. Arithmetic intensity is an index that increases when the number of calculations is large and decreases when the number of accesses is large, and processing with high arithmetic intensity becomes heavy processing for the processor. Therefore, an arithmetic intensity analysis tool is used to analyze the arithmetic intensity of loop statements and narrow down loop statements with high density to offload candidates. Therefore, an arithmetic intensity analysis tool is used to analyze the arithmetic intensity of loop statements and narrow down loop statements with high density to offload candidates.

Even if the loop statement of high arithmetic intensity is processed by the FPGA, it is a problem that FPGA resources are excessively consumed. Therefore, how to calculate the amount of resources when processing a high arithmetic intensity loop statement on an FPGA will be described.

As the processing of compiling for the FPGA, a high-level language such as OpenCL is converted into a level of HDL or the like in hardware description, and actual wiring processing or the like is performed based on the hardware description. At this time, wiring processing or the like takes a long time, but it takes only a minute time to the stage of the middle state of HDL or the like. Even in the stage of the middle state of HDL or the like, resources such as Flip Flop and Look up Table used in the FPGA can be known. Therefore, the resource amount to be used can be found in a short time without completing the compiling by finding the stage of the middle state of HDL or the like.

Therefore, in the present embodiment, the PLD processing pattern creation unit 215 converts the target loop statement into a high-level language such as OpenCL, and first calculates the amount of resources. Since the arithmetic intensity and resource amount when the loop statement is offloaded are determined, the arithmetic intensity/resource quantity or arithmetic intensity x loop number/resource quantity is defined as resource efficiency. Then, the loop statement of high resource efficiency is further narrowed down as the offload candidate.

Returning to the flow of FIG. 17, in step S204, the PLD processing pattern creation unit 215 measures the loop count of the loop statement of the application using a profiling tool such as gcov or gprof.

In step S205, the PLD processing pattern creation unit 215 narrows down the loop statements with high arithmetic intensity and a high loop count from among the loop statements.

In step S206, the PLD processing pattern creation unit 215 creates OpenCL for offloading each narrowed-down loop statement to the FPGA.

Here, a supplementary explanation of converting loop statements to OpenCL (creating OpenCL) will be provided. In other words, two processes are required when converting a loop statement into a high-level language using OpenCL or the like. One is to divide a CPU processing program into a kernel (FPGA) and a host (CPU) according to the syntax of a high-level language such as OpenCL. The other is to incorporate a technique for speeding up at the time of division. In general, in order to increase the speed by using the FPGA, a local memory cache, a stream processing, a plurality of instances, a processing for developing loop statements, an integration of nested loop statements, a memory interleaving, and the like are used. Although there is no absolute effect depending on the loop statement, these are often used as a method for increasing the speed of the loop statement.

Next, since some loop statements of high resource efficiency are selected, the number of offload patterns for actually measuring performance are created by using them. In the FPGA speed up, there are some cases where the FPGA resource amount is concentrated to only one processing to accelerate the FPGA, or FPGA resources are distributed to a plurality of processes to accelerate the FPGA. A fixed number of selected single-loop statement patterns are created and precompiled as a step before running on an actual FPGA device.

In step S207, the PLD processing pattern creation unit 215 precompiles the created OpenCL and calculates the amount of resources to be used (“first resource amount calculation”).

In step S208, the PLD processing pattern creation unit 215 narrows down loop statements with high resource efficiency.

In step S209, the executable file creation unit 119 compiles OpenCL that offloads the narrowed-down loop statements.

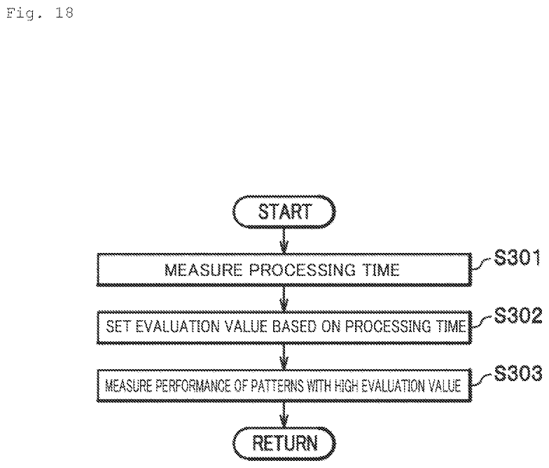

In step S210, the performance measuring unit 118 measures the performance of the compiled program (“first performance measurement”). Since some candidate loop statements remain, the performance measuring unit 118 uses them to actually measure the performance (for details, see the subroutine in FIG. 18).

In step S211, the PLD processing pattern creation unit 215 creates a list of loop statements whose performance has been improved compared to that of the CPU among those whose performance has been measured.

In step S212, the PLD processing pattern creation unit 215 creates OpenCL for offloading by combining the loop statements in the list.

In step S213, the PLD processing pattern creation unit 215 precompiles the loop statement using the combined offload OpenCL to calculate the amount of resources to be used (“second resource amount calculation”). Note that instead of precompiling, it is also possible to use the sum of the resource amounts in precompiling before the first measurement. Thus, the number of times of precompiling can be reduced.

In step S214, the executable file creation unit 119 compiles the combined offload OpenCL.

In step S215, the performance measuring unit 118 measures the performance of the compiled program (“second performance measurement”). The performance measuring unit 118 compiles and measures the selected single-loop statement, and also creates a combination pattern for the single-loop statement whose speed can be further increased and performs a second performance measurement (for details, see the subroutine in FIG. 18).

In step S216, the production environment deployment unit 120 selects the pattern with the highest performance among the first and second measurements, and ends the processing of this flow. Among the plurality of measured patterns, a short-time pattern is selected as a solution.

In this way, FPGA automatic offloading of loop statements creates offload patterns by narrowing down to loop statements with high arithmetic intensity, high loop count, and high resource efficiency, and searches for high-speed patterns through actual measurements in a verification environment (see FIG. 17).

FIG. 18 is a flowchart showing the performance/power usage measurement processing of the performance measuring unit 118. This flow is called and executed by the subroutine call in step S210 or step S215 in FIG. 17.

In step S301, the performance measuring unit 118 measures the processing time required during FPGA offloading.

In step S302, the performance measuring unit 118 sets an evaluation value based on the measured processing time.

In step S303, the performance measuring unit 118 measures the performance of the patterns with high evaluation values evaluated such that the higher the evaluation value of the gene, the higher the degree of fitness, and the processing returns to step S210 or step S215 in FIG. 17.

### Example of Creating an Offload Pattern

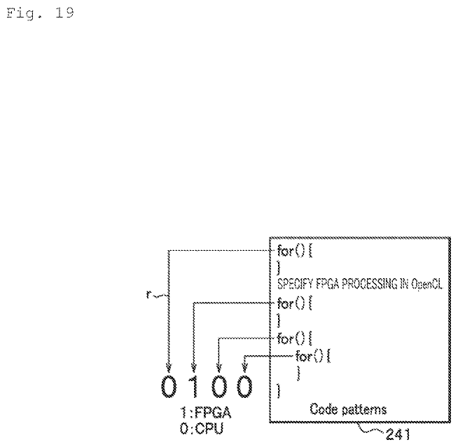

FIG. 19 is a diagram showing a search image of the PLD processing pattern creation unit 215.

The control unit (automatic offload function unit) 21 (see FIG. 16) analyzes the application code 125 (see FIG. 2) used by the user, and checks whether the for statement can be parallelized from the code patterns 241 of the application code 125 as shown in FIG. 19. As indicated by symbol r in FIG. 19, when four for statements are found from the code patterns 241, one digit is assigned to each for statement, in this case, four digits of 1 or 0 are assigned to the four for statements. Here, it is set to 1 when FPGA processing is performed, and 0 when not processed by FPGA (that is, when processed by CPU).

[Flow from C Code to OpenCL Final Solution Search]

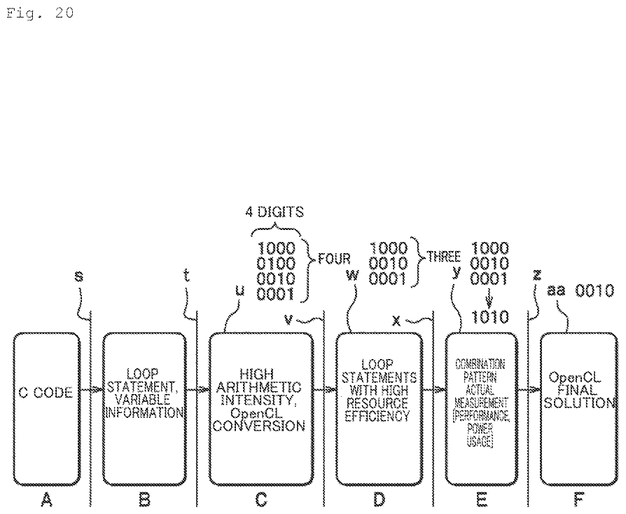

Steps A to F in FIG. 20 are diagrams explaining the flow from the C code to the search for the OpenCL final solution.

The application code analysis unit 112 (see FIG. 16) parses the “C code” shown in step A of FIG. 20 (<parsing>: see symbol s in FIG. 20), and the PLD processing specifying unit 213 (see FIG. 16) specifies the “loop statement, variable information” shown in step B of FIG. 20 (see symbol t in FIG. 20).

The arithmetic intensity calculation unit 214 (see FIG. 16) performs arithmetic intensity analysis on the identified “loop statement, variable information” using an arithmetic intensity analysis tool (see symbol u in FIG. 20). The PLD processing pattern creation unit 215 narrows down loop statements with high arithmetic intensity to offload candidates. Further, the PLD processing pattern creation unit 215 performs profiling analysis using a profiling tool to further narrow down loop statements with high arithmetic intensity and a high loop count.

Then, the PLD processing pattern creation unit 215 creates OpenCL (converts it into OpenCL) for offloading each narrowed-down loop statement to the FPGA (see symbol v in FIG. 20). Furthermore, when converting to OpenCL, speed-up methods such as code splitting and expansion will be introduced (described later).

### Specific Example of “High Arithmetic Intensity, OpenCL Conversion” (Part 1): Step C

For example, if four for statements (assignment of 1 or 0 to four digits) are found in the code pattern 241 (see FIG. 19) of the application code 125 (see FIG. 2), three are selected using arithmetic intensity analysis. That is, as indicated by symbol u in FIG. 20, the offload patterns of three for statements “1000,” “0010,” and “0001” are selected from the four for statements.

### Example of “Deployment” Executed with Code Division when Converting to OpenCL

When transferring data from the FPGA to the CPU, \pragma unroll is specified at the top of the loop statement [k=0; k<10; k++]{ } written on the CPU program side.

In other words, \pragma unrollfor(k=0; k<10; k++){ } is written.

If unroll is specified using a syntax suitable for Intel or Xilinx (registered trademark) tools such as \pragma unroll, the above expansion example will be expanded to i=0, i=1, i=2 and executed in pipeline. Therefore, ten times the resource amount will be used, but it may be faster.

It is also possible to specify that the number to be expanded with unroll is 5 instead of the total loop count, in which case each loop will be expanded two times to five loops. This concludes the explanation of the “deployment” example. Next, the PLD processing pattern creation unit 215 further narrows down the loop statements with high arithmetic intensity narrowed down as offload candidates using the amount of resources. That is, the PLD processing pattern creation unit 215 calculates the resource amount, and the PLD processing pattern creation unit 215 analyzes the resource efficiency (=(arithmetic intensity)/(resource amount during FPGA processing), or (arithmetic intensity)x(loop count)/(resource amount during FPGA processing)) from among the offload candidates for the loop statement with high arithmetic intensity to extract loop statements with high resource efficiency.

At symbol v in FIG. 20, the PLD processing pattern creation unit 215 compiles (<precompile>) OpenCL for offloading the narrowed-down loop statement.

### Specific Example of “High Arithmetic Intensity, OpenCL Conversion” (Part 2)

As indicated by symbol u in FIG. 20, the four offload patterns “1000,” “0100,” “0010,” and “0001” narrowed down by the arithmetic intensity analysis are narrowed down to three offload patterns “1000,” “0010,” and “0001” by the resource efficiency analysis.

The “high arithmetic intensity, OpenCL conversion” shown in step C of FIG. 20 has been explained above.

The performance measuring unit 118 measures the performance of the compiled program for the “loop statement with high resource efficiency” shown in step D of FIG. 20 (“first performance measurement”).

Then, the PLD processing pattern creation unit 215 creates a list of loop statements whose performance has been improved compared to the CPU among those whose performance has been measured. Below, the amount of resources is similarly calculated, offload OpenCL is compiled, and the performance of the compiled program is measured.

### Specific Example of “High Arithmetic Intensity, OpenCL Conversion” (Part 3)

As indicated by symbol w in FIG. 20, the first measurement is performed for three offload patterns “1000”, “0010”, and “0001”. Among the three measurements, if the performance of two of “1000” and “0010” is high, a second measurement is performed for the combination of “1000” and “0010”.

At symbol x in FIG. 20, the executable file creation unit 119 compiles OpenCL for offloading the narrowed-down loop statement (<main compiling>).

The “combination pattern actual measurement” shown in step E in FIG. 20 refers to measuring a verification pattern for a single candidate loop statement and then for its combination.

### Specific Example of “High Arithmetic Intensity, OpenCL Conversion” (Part 4)

As indicated by symbol y in FIG. 20, the second measurement is performed for “1010” which is a combination of “1000” and “0010”. Measurements were taken twice, and as a result, the highest speed pattern “0010” was selected through the first and second measurements. In such a case, “0010” will be the final solution. Here, the combination pattern may not be measurable due to resource amount limitations. In this case, it is possible to skip the combination and just choose the fastest one from the results of individual patterns.

At symbol z in FIG. 20, the performance measuring unit 118 selects (<selection>) “0010” which has the best highest speed among the first measurement and the second measurement.

As a result of the above, “0010” (see symbol aa in FIG. 20) of “OpenCL final solution” shown in step F of FIG. 20 was selected.

### <Deployment>

The PLD processing pattern with the highest processing performance, which is the final OpenCL solution, will be redeployed to the production environment and provided to users.

### Implementation Example

An implementation example will be explained.

FPGAs such as Intel PAC with Intel Arria10 GX FPGA can be used.

For FPGA processing, Intel Acceleration Stack (Intel FPGA SDK for OpenCL, Quartus Prime Version) or the like can be used. Intel FPGA SDK for OpenCL is a high-level synthesis tool (HLS) that interprets #pragma or the like for Intel in addition to standard OpenCL.

In the implementation example, the OpenCL code that describes the kernel to be processed by the FPGA and the host program to be processed by the CPU is interpreted, information such as the amount of resources is output, and wiring work for the FPGA is performed so that it can operate on the FPGA. Even a small program with about 100 lines takes about three hours to run on an actual FPGA device. However, if the amount of resources is exceeded, an error will occur sooner. Additionally, if the OpenCL code cannot be processed by the FPGA, an error will be output after several hours.

In the implementation example, when there is a request to use a C/C++ application, first, the code of the C/C++ application is analyzed to discover the for statement and understand the program structure such as variable data used in the for statement. For syntax analysis, it is possible to use the LLVM/Clang syntax analysis library.

In the implementation example, next, in order to obtain an estimate of whether there is an FPGA offloading effect for each loop statement, an arithmetic intensity analysis tool is executed to obtain an index of arithmetic intensity determined by the number of calculations, number of accesses, and the like The ROSE framework or the like can be used for arithmetic intensity analysis. Only loop statements with high arithmetic intensity are subjected to the analysis.

Next, a profiling tool such as gcov is used to obtain the loop count of each loop. The candidates are narrowed down to the top a loop statements in terms of arithmetic intensity x loop count.

In the implementation example, then, OpenCL code is generated to offload the FPGA for each loop statement with high arithmetic intensity. The OpenCL code is divided into the corresponding loop statement as the FPGA kernel and the rest as the CPU host program. When creating the FPGA kernel code, only a certain number b of loop statements may be expanded as a speed-up technique. Loop statement expansion processing increases the amount of resources, but is effective in speeding up processing. Therefore, the number of deployments is limited to a certain number b so that the amount of resources does not become enormous.

In the implementation example, next, a number of OpenCL codes are precompiled using the Intel FPGA SDK for OpenCL, and the amount of resources such as Flip Flop and Look Up Table to be used is calculated. The used resource amount is displayed as a percentage of the total resource amount. Here, the resource efficiency of each loop statement is calculated from the arithmetic intensity and the resource amount, or the arithmetic intensity, the loop count, and the resource amount. For example, a loop statement with an arithmetic intensity of 10 and a resource amount of 0.5 has a resource efficiency of 10/0.5=20, and a loop statement with an arithmetic intensity of 3 and a resource amount of 0.3 has a resource efficiency of 3/0.3=10. The former has higher resource efficiency. Alternatively, the resource efficiency may be the value multiplied by the loop count. For each loop statement, c items with high resource efficiency are selected.

In the implementation example, next, a pattern to be actually measured is created using c loop statements as candidates. For example, if the first and third loops have high resource efficiency, OpenCL patterns that offload first and third loops are created and compiled, and their performance is measured. If the offload pattern of multiple single-loop statements can speed up processing (for example, if both the first and third loops can speed up processing), an OpenCL pattern for that combination is created and compiled, and the performance is measured (for example, a pattern that offloads both the first and third loops).

Note that when creating a combination of single loops, the amount of resources used is also included in the combination. Therefore, if the value does not fall within the upper limit, that combination pattern will not be created. When d patterns are created, including combinations, performance is measured on a server equipped with an FPGA in the verification environment. To measure performance, sample processing specified by the application that is desired to be sped up is performed. For example, in the case of a Fourier transform application, performance is measured using the transform processing on sample data as a benchmark.

In the implementation example, a high-speed pattern among the plurality of measurement patterns is finally selected as the solution.

The second embodiment also executes “resource amount determination and deployment determination” similar to that described in the first embodiment (description omitted).

### [Evaluation]

The evaluation will be explained.

The [FPGA automatic offload of loop statement] in the second embodiment can be evaluated in the same way as the [GPU automatic offload of loop statement] in the first embodiment.

### <Evaluation Target>

The evaluation target is MRI-Q of MRI (Magnetic Resonance Imaging) image processing in the [FPGA automatic offloading of loop statements] of the second embodiment.

MRI-Q calculates a matrix Q representing the scanner configuration used in 3D MRI reconstruction algorithms in non-Cartesian space. MRI-Q is written in C language, performs 3D MRI image processing during performance measurement, and measures processing time using large (maximum) data of size 64×64×64. CPU processing is performed using C language, and FPGA processing is performed based on OpenCL.

### <Evaluation Method>

The code of the target application is input, offloading of loop statements recognized by Clang and or like to the destination GPU or FPGA is tried, and the offload pattern is determined. At this time, processing time and power consumption are measured. For the final offload pattern, the temporal changes in power usage are obtained and the power savings compared to when all processing is done by the CPU is confirmed.

In the [FPGA automatic offload of loop statements] of the second embodiment, GA is not performed, but arithmetic intensity and the like are used to narrow down the measurement patterns to four patterns.
Loop statements to be offloaded: MRI-Q 16
Pattern fitness: The lower the processing time, the higher the evaluation value and the higher the fitness. In the MRI-Q of the second embodiment, as shown in FIG. 12 described above, cost and response time can be improved compared to a deployment that simply prioritizes cost and response time.

In the first embodiment, the deployment reconfiguration unit 180 reconfigures the deployment locations of the application program group requested by a plurality of users to be reconfigured among the deployed application programs set by the deployment setting unit 170 according to the linear programming equations for reconfiguration (see Equations (7), (1), (5), (3) and (4)). In the second embodiment, similarly to the first embodiment, the deployment reconfiguration unit 180 executes the reconfiguration processing.

### [Hardware Configuration]

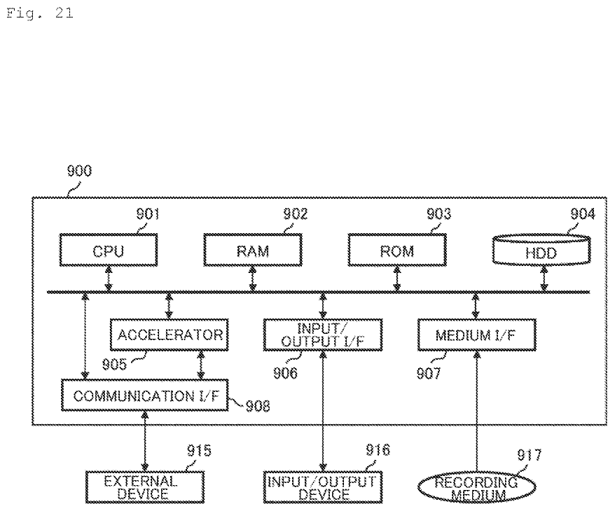

The offload server according to the first and second embodiments is realized by a computer 900, which is a physical device configured as shown in FIG. 21, for example.

FIG. 21 is a hardware configuration diagram showing an example of a computer that implements the functions of the offload servers 1 and 1A. The computer 900 has a CPU 901, a RAM 902, a ROM 903, an HDD 904, an accelerator 905, an input/output interface (I/F) 906, a media interface (I/F) 907, and a communication interface (I/F) 908.

The accelerator 905 is an accelerator (device) that processes at least one of the data from the communication I/F 908 and the data from the RAM 902 at high speed. For example, the accelerator 905 is an accelerator for various devices 151 in FIG. 2, the device 152 with CPU-GPU, the device 153 with CPU-FPGA, and the device 154 with CPU.

Note that the accelerator 905 may be of a type (look-aside type) that returns the execution result to the CPU 901 or RAM 902 after executing processing from the CPU 901 or RAM 902. On the other hand, as the accelerator 905, a type (in-line type) that is inserted between the communication I/F 908 and the CPU 901 or the RAM 902 and performs processing may be used.

The accelerator 905 is connected to an external device 915 via the communication I/F 908. The input/output I/F 906 is connected to an input/output device 916. The medium I/F 907 reads and writes data from and to a recording medium 917.

The CPU 901 operates based on the program stored in the ROM 903 or the HDD 904, and executes the program (also called an application or an abbreviation thereof) loaded in the RAM 902, whereby control is performed by each processing unit of the offload servers 1 and 1A shown in FIGS. 1 and 16. This program can also be distributed through a communication line or recorded and distributed on the recording medium 917 such as a CD-ROM.

The ROM 903 stores a boot program executed by the CPU 901 when the computer 900 is started, programs depending on the hardware of the computer 900, and the like.

The CPU 901 controls, via the input/output I/F 906, the input/output device 916 consisting of input units such as a mouse and keyboard, and output units such as a display and a printer. The CPU 901 obtains data from the input/output device 916 via the input/output I/F 906, and outputs the generated data to the input/output device 916. A GPU (Graphics Processing Unit) or the like may be used as the processor together with the CPU 901.

The HDD 904 stores a program executed by the CPU 901, data used by the program, and the like. The communication I/F 908 receives data from other devices via a communication network (for example, NW (Network)) and outputs it to the CPU 901, and also sends data generated by the CPU 901 to other devices via the communication network.

The medium I/F 907 reads a program or data stored in the recording medium 917 and outputs it to the CPU 901 via the RAM 902. The CPU 901 loads a program related to target processing from the recording medium 917 onto the RAM 902 via the medium I/F 907, and executes the loaded program. The recording medium 917 is an optical recording medium such as a digital versatile disc (DVD), a phase change rewritable disk (PD), a magneto-optical recording medium such as a magneto optical disk (MO), a magnetic recording medium, a conductor memory tape medium, a semiconductor memory, and the like.

For example, when the computer 900 functions as the offload servers 1 and 1A according to the first and second embodiments, the CPU 901 of the computer 900 realizes the functions of the offload servers 1 and 1A by executing the program loaded on the RAM 902. Furthermore, the data in the RAM 902 is stored in the HDD 904. The CPU 901 reads a program related to target processing from the recording medium 912 and executes the program. In addition, the CPU 901 may read a program related to target processing from another device via a communication network.

### [Effects]

As explained above, the offload server 1 (see FIG. 1) according to the first embodiment is an offload server that offloads specific processing of an application program to an accelerator. The offload server includes the application code analysis unit 112 that analyzes a source code of the application program; the data transfer specifying unit 113 that analyzes reference relationships of variables used in loop statements of the application program, and, for data that can be transferred outside the loop, specifies data transfer using explicit specification lines that explicitly specify data transfer outside the loop; the parallel processing specifying unit 114 that identifies loop statements in the application program, and specifies and compiles each of the identified loop statements by specifying a parallel processing specifying statement in the accelerator; the parallel processing pattern creation unit 117 that excludes loop statements that cause compile errors from being offloaded, and creates a parallel processing pattern that specifies whether to perform parallel processing for loop statements that do not cause compile errors; the performance measuring unit 118 that compiles the application program of the parallel processing pattern, deploys it on an accelerator verification device, and executes processing of measuring performance when offloaded to the accelerator; and the deployment reconfiguration unit 180 that reconfigures deployment locations of a group of application programs requested to be deployed by a plurality of users requesting deployment of reconfiguration target applications according to a linear programming equation for reconfiguration (see Equations (7), (1), (5), (3), and (4)) for the deployed application programs.

By doing so, it is possible to improve the satisfaction level of a plurality of users who request the deployment of the reconfiguration target application by reconfiguring the deployment after the start of operation.

In other words, if applications are deployed according to the response time and price requirements of individual users, it is basically first come first served. For example, if there are only requests that prioritize price, the cloud will be filled, and if there are only requests that prioritize speed, the edge will be filled. Once the cloud or edge is full, it is necessary to deploy it on another server. Therefore, the offload server 1 (see FIG. 1) includes the deployment reconfiguration unit 180, and reconfigures the deployment not only before the start of operation but also after the start of operation. This alleviates the first-come, first-served deployment and improves the satisfaction level of multiple users who request the deployment of reconfiguration target applications.

According to the present invention, for applications that are automatically offloaded to GPUs and FPGAs, after satisfying the user's requests such as price conditions and response time conditions, it becomes possible to achieve an overall optimal deployment that improves overall user satisfaction level linked to price and response time based on the application deployment status of other users.

The offload server 1A (see FIG. 16) according to the second embodiment is an offload server that offloads specific processing of an application program to a PLD. The offload server includes: the application code analysis unit 112 that analyzes a source code of the application program; the PLD processing specifying unit 213 that identifies loop statements in the application program and creates and compiles pipeline processing and parallel processing in the PLD using a plurality of offload processing patterns specified in OpenCL for each of the identified loop statements; the arithmetic intensity calculation unit 214 that calculates an arithmetic intensity of a loop statement of the application program; the PLD processing pattern creation unit 215 that narrows down loop statements whose arithmetic intensity is higher than a predetermined threshold as offload candidates based on the arithmetic intensity calculated by the arithmetic intensity calculation unit 214 and creates a PLD processing pattern; the performance measuring unit 118 that compiles the application program of the created PLD processing pattern, deploys it on an accelerator verification device, and executes processing of measuring performance when offloaded to the PLD; and the deployment reconfiguration unit 180 that reconfigures deployment locations of a group of application programs requested to be deployed by a plurality of users requesting deployment of reconfiguration target applications according to a linear programming equation for reconfiguration (see Equations (7), (1), (5), (3), and (4)) for the deployed application programs.

By doing this, it is possible to reduce the number of performance measurement times by narrowing down the patterns to actually measure performance, deploying them in the verification environment, compiling them, and measuring performance on the actual PLD (for example, FPGA) device. Due to this, automatic offloading of loop statements of applications to the PLD can be performed at high speed. Then, an appropriate deployment of the converted applications on either a cloud server, carrier edge server, or user edge server on the network is calculated by changing the price conditions, response time conditions, number of applications, and the like requested by the user. As a result, the converted application can be optimally deployed in accordance with the user's requests while satisfying the computation resource cost or response time requirements. Further, since the deployment reconfiguration unit 180 reconfigures the deployment after the start of operation, it is possible to improve the satisfaction level of the plurality of users who request the deployment of the reconfiguration target application.

The offload server 1 according to the first embodiment (see FIG. 1) and/or the offload server 1A according to the second embodiment (see FIG. 16) further includes further includes the deployment setting unit 170 that, when deploying the converted application program on a cloud server, a carrier edge server, or a user edge server on a network depending on cost or response time conditions specified by the user, calculates and sets the deployment location of the application program based on a linear programming equation using the cost, the upper limit of computation resources, and the upper limit of bandwidth of devices and links as constraint conditions and the cost or response time of computation resources as an objective function, and the deployment reconfiguration unit 180 reconfigures deployment locations of a group of application programs requested to be deployed by a plurality of users requesting deployment of reconfiguration target applications according to a linear programming equation for reconfiguration for the deployed application programs set by the deployment setting unit 170.

By doing so, an appropriate deployment of applications that have been automatically offloaded to accelerators such as GPUs and FPGAs on either a cloud server, carrier edge server or user edge server on the network is calculated by changing the price conditions, response time conditions, number of applications, and the like requested by users. As a result, the converted application can be optimally deployed in accordance with the user's requests while satisfying the computation resource cost or response time requirements. Further, since the deployment reconfiguration unit 180 reconfigures the deployment after the start of operation, it is possible to improve the satisfaction level of the plurality of users who request the deployment of the reconfiguration target application.

In the offload servers 1 and 1A according to the first and second embodiments, the deployment setting unit 170 calculates a deployment that minimizes the cost of computation resources or minimizes response time when an application program is deployed on the server. The feature is that it calculates the deployment.

By doing so, the converted application can be optimally deployed according to the requirements for computation resource cost or response time.

In the offload servers 1 and 1A according to the first and second embodiments, the deployment reconfiguration unit 180 uses the sum of the application program groups related to user satisfaction level evaluation shown in Equation (7) as an objective function, and calculates the objective function to be the minimum, and the application program group is redeployed in batches to the position determined by the calculation.

By doing so, the deployment reconfiguration unit 180 calculates the deployment that minimizes the sum of (Rₖ^{after}/Rₖ^{before}+Pₖ^{after}/Pₖ^{before}) for multiple applications according to the objective function of Equation (7): Rₖ^{after}/Rₖ^{before}+Pₖ^{after}/Pₖ^{before}. Therefore, the value S corresponding to the user satisfaction level in Equation (7) is calculated, and the overall user satisfaction level can be improved.

The present invention provides an offload program for causing a computer to function as the above-mentioned offload server.

By doing so, each function of the offload servers 1 and 1A can be realized using a general computer.

In addition, in each type of processing described in each present embodiment, all or some processing described as being automatically performed can be manually performed. Alternatively, all or some processing described as being manually performed can be automatically performed by known methods. Furthermore, information including processing procedures, control procedures, specific names, and various types of data and parameters set forth in the description and drawings given above can be arbitrarily changed unless otherwise specified.

In addition, the elements of the devices shown are ideational functions and may not be necessarily configured as physically shown. That is, the specific form of distribution and integration of the respective devices is not limited to the shown form, and all or a part thereof can be configured to be functionally or physically distributed and integrated in any unit according to various loads, usage conditions, and the like.

In addition, the above configurations, functions, processing units, processing means, and the like may be realized by hardware by designing a part or all of them with, for example, an integrated circuit, and the like. Further, the above-mentioned structures, functions, and the like may be realized by software for interpreting and executing programs for realizing the respective functions by the processor. Information such as programs, tables, and files that realize each function can be stored in a memory, a recording device such as a hard disk, or an SSD (Solid State Drive), or a recording medium such as an IC (Integrated Circuit) card, an SD (Secure Digital) card, or an optical disk.

Furthermore, in the present embodiment, a genetic algorithm (GA) method is used to solve the combinatorial optimization problem in order to find a solution within a limited optimization period, but the optimization method is not limited thereto. For example, local search, dynamic programming, or a combination thereof may be used.

Further, in the present embodiment, an OpenACC compiler for C/C++ is used, but any compiler may be used as long as it can offload GPU processing. For example, Java lambda (registered trademark) GPU processing or IBM Java 9 SDK (registered trademark) may be used. Note that the parallel processing specifying statement depends on these development environments.

For example, in Java (registered trademark), parallel processing descriptions in the lambda format are possible using Java 8. IBM (registered trademark) provides a JIT compiler that offloads lambda-format parallel processing descriptions to GPUs. In Java, similar offloading is possible by using these techniques to tune whether to use lambda format for loop processing using GA.

Furthermore, in the present embodiment, a for statement is exemplified as a repetition statement (loop statement), but a while statement and a do-while statement other than the for statement may also be used. However, a for statement that specifies the continuation conditions of the loop is more suitable.

### REFERENCE SIGNS LIST

1, 1A Offload server
11, 21 Control unit
12 Input/output unit
13 Storage unit
14 Verification machine (accelerator verification device)
111 Application code specifying unit
112 Application code analysis unit
113 Data transfer specifying unit
114 Parallel processing specifying unit
114a, 213a Offload range extraction unit
114b, 213b Intermediate language file output unit
115 Resource ratio determination unit
116 Resource amount setting unit
117 Parallel processing pattern creation unit
118 Performance measuring unit
118a Binary file deployment unit
119 Executable file creation unit
120 Production environment deployment unit
121 Performance measurement test extraction execution unit
122 User providing unit
125 Application code
131 Test case DB
132 Equipment resource DB
133 Intermediate language file
151 Various devices
152 Device with CPU-GPU
153 Device with CPU-FPGA
154 Device with CPU
170 Deployment setting unit
180 Deployment reconfiguration unit
213 PLD processing specifying unit
214 Arithmetic intensity calculation unit
215 PLD processing pattern creation unit
905 Accelerator
S Value corresponding to user satisfaction level (objective function for evaluating user satisfaction level) (linear programming equation for reconfiguration)

1. An offload server that offloads specific processing of an application program to an accelerator, the offload server comprising:
an application code analysis unit, including one or more processors, configured to analyze a source code of the application program;
a data transfer specifying unit including one or more processors, configured to analyze reference relationships of variables used in loop statements of the application program, and, for data that can be transferred outside the loop, specify data transfer using explicit specification lines that explicitly specify data transfer outside the loop;
a parallel processing specifying unit including one or more processors, configured to identify loop statements in the application program, and specify and compiles each of the identified loop statements by specifying a parallel processing specifying statement in the accelerator;
a parallel processing pattern creation unit including one or more processors, configured to exclude loop statements that cause compile errors from being offloaded, and create a parallel processing pattern that specifies whether to perform parallel processing for loop statements that do not cause compile errors;
a performance measuring unit, including one or more processors, configured to compile the application program of the parallel processing pattern, deploy it on an accelerator verification device, and execute processing of measuring performance when offloaded to the accelerator; and
a deployment reconfiguration unit including one or more processors, configured to reconfigure deployment locations of a group of application programs requested to be deployed by a plurality of users requesting deployment of reconfiguration target applications according to a linear programming equation for reconfiguration for the deployed application programs.

2. An offload server that offloads specific processing of an application program to a PLD (Programmable Logic Device), the offload server comprising:
an application code analysis unit, including one or more processors, configured to analyze a source code of the application program;
a PLD processing specifying unit, including one or more processors, configured to identify loop statements in the application program and creates and compile pipeline processing and parallel processing in the PLD using a plurality of offload processing patterns specified in OpenCL for each of the identified loop statements;
an arithmetic intensity calculation unit, including one or more processors, configured to calculate an arithmetic intensity of a loop statement of the application program;
a PLD processing pattern creation unit including one or more processors, configured to narrow down loop statements whose arithmetic intensity is higher than a predetermined threshold as offload candidates based on the arithmetic intensity calculated by the arithmetic intensity calculation unit and creates a PLD processing pattern;
a performance measuring unit, including one or more processors, configured to compile the application program of the created PLD processing pattern, deploy it on an accelerator verification device, and execute processing of measuring performance when offloaded to the PLD; and
a deployment reconfiguration unit including one or more processors, configured to reconfigure deployment locations of a group of application programs requested to be deployed by a plurality of users requesting deployment of reconfiguration target applications according to a linear programming equation for reconfiguration for the deployed application programs.

3. The offload server according to claim 1, further comprising:
a deployment setting unit including one or more processors, configured to, when deploying the converted application program on a cloud server, a carrier edge server, or a user edge server on a network depending on cost or response time conditions specified by the user, calculate and set the deployment location of the application program based on a linear programming equation using the cost, the upper limit of computation resources, and the upper limit of bandwidth of devices and links as constraint conditions and the cost or response time of computation resources as an objective function, wherein
the deployment reconfiguration unit is configured to reconfigure deployment locations of a group of application programs requested to be deployed by a plurality of users requesting deployment of reconfiguration target applications according to a linear programming equation for reconfiguration for the deployed application programs set by the deployment setting unit.

4. The offload server according to claim 3, wherein
the deployment setting unit is configured to calculate a deployment that minimizes the cost of computation resources or a deployment that minimizes the response time when the application program is deployed on the server.

5. The offload server according to claim 1, wherein
the deployment reconfiguration unit is configured use a sum of the group of application programs related to user satisfaction level evaluation shown in the following equation as an objective function, calculate a deployment that minimizes the objective function, and redeploys the group of application programs in batches at a position determined by
$$S = {\sum }_{k ∈ App} ( \frac{{R}_{k}^{after}}{{R}_{k}^{before}} + \frac{{P}_{k}^{after}}{{P}_{k}^{before}} ) .$$

6. An offload control method for an offload server that offloads specific processing of an application program to an accelerator, the method comprising:
causing the offload server to execute:
analyzing a source code of the application program;
analyzing reference relationships of variables used in loop statements of the application program, and, for data that can be transferred outside the loop, specifying data transfer using explicit specification lines that explicitly specify data transfer outside the loop;
identifying loop statements in the application program, and specifying and compiling each of the identified loop statements by specifying a parallel processing specifying statement in the accelerator;
excluding loop statements that cause compile errors from being offloaded, and creating a parallel processing pattern that specifies whether to perform parallel processing for loop statements that do not cause compile errors;
compiling the application program of the parallel processing pattern, deploying it on an accelerator verification device, and executing processing of measuring performance when offloaded to the accelerator; and
reconfiguring deployment locations of a group of application programs requested to be deployed by a plurality of users requesting deployment of reconfiguration target applications according to a linear programming equation for reconfiguration for the deployed application programs.

7. (canceled)

8. An offload program for causing a computer to function as an offload server according to claim 1.
